(19) United States
(12) Patent Application Publication
(10) Pub. No.: US 2022/0377831 A1
(43) Pub. Date: Nov. 24, 2022

(54) TIMER OPERATIONS FOR DIRECTIONAL SIDELINK DISCONTINUOUS RECEPTION

(71) Applicant: QUALCOMM Incorporated, San Diego, CA (US)

(72) Inventors: Qing Li, Princeton Junction, NJ (US); Junyi Li, Fairless Hills, PA (US); Seyedkianoush Hosseini, San Diego, CA (US); Hong Cheng, Basking Ridge, NJ (US); Ozcan Ozturk, San Diego, CA (US)

(21) Appl. No.: 17/722,521

(22) Filed: Apr. 18, 2022

Related U.S. Application Data
(60) Provisional application No. 63/192,499, filed on May 24, 2021.

(51) Int. Cl. H04W 76/28

(52) U.S. Cl. CPC H04W 76/28

(57) ABSTRACT

Methods, systems, and devices for wireless communications are described. A first user equipment (UE) may receive a message indicating a configuration for a first active duration for the first UE, the first active duration being for a reversed communication direction during an active duration of a first discontinuous cycle for sidelink communications. The first UE may transmit a sidelink signal to the second UE, and may activate the first time active duration during the active duration of the first discontinuous cycle. Upon activating the first active duration, the first UE may switch from a transmission mode to a reception mode, and may receive a sidelink response message from the second UE during the first active duration. Based on receiving the sidelink response message, the first UE may switch back to the transmission mode to the reception mode during the first active duration, and may terminate the first active duration.

### CROSS REFERENCE

The present Application for Patent claims the benefit of U.S. Provisional Patent Application No. 63/192,499 by LI et al., entitled “TIMER OPERATIONS FOR DIRECTIONAL SIDELINK DISCONTINUOUS RECEPTION,” filed May 24, 2021, assigned to the assignee hereof, and expressly incorporated by reference herein.

### FIELD OF TECHNOLOGY

The following relates to wireless communications, including timer operations for directional sidelink discontinuous reception (DRX).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (e.g., network entities) or one or more network access nodes, each simultaneously supporting communication for multiple communication devices, which may be otherwise known as user equipment (UE).

In some wireless communications systems, a UE may communicate with another UE using coordinated communications during an active duration of a sidelink discontinuous cycle, such as a discontinuous reception (DRX) cycle or a discontinuous transmission (DTX) cycle.

### SUMMARY

The described techniques relate to improved methods, systems, devices, and apparatuses that support timer operations for directional sidelink discontinuous reception (DRX). Generally, the described techniques provide for a user equipment (UE) to be pre-configured if out of network coverage or to be configured by base station (e.g., network entity) if in network coverage one or more UE with a timer (e.g., an active duration), such that the UEs may switch communication directions (e.g., from a transmission mode to a reception mode, or from a reception mode to a transmission mode) for the duration of the timer and during an ON duration of a directional sidelink DRX cycle. For example, a first UE may transmit a sidelink message during a transmission on (Tx-ON) duration of a first directional DRX cycle to a second UE. In some examples, rather than waiting for the Tx-ON duration to end and then entering a reception on (Rx-ON) duration of a second directional DRX cycle, to a receive mode, the first UE may activate the timer after transmitting the sidelink message and may switch to a reception mode for a Tx-ON duration, and the second UE may switch to a transmission mode. The second UE may process the sidelink signal and may transmit a sidelink response message to the first UE during the Tx-ON duration. Upon receiving the sidelink response, and still during the Tx-ON duration, the first UE may switch back to a transmission mode and the second UE may switch to a reception mode.

A method for wireless communications at a first UE is described. The method may include receiving a message indicating a configuration for a first active duration for the first UE, the first active duration being for a reversed communication direction during an active duration of a first discontinuous cycle for sidelink communications for the first UE, transmitting, within the active duration of the first discontinuous cycle, a sidelink signal to a second UE, activating the first active duration based on transmitting the sidelink signal based on the configuration, switching from a transmission mode to a reception mode during the first active duration based on activating the first active duration, receiving, based on switching from the transmission mode to the reception mode, a sidelink response to the sidelink signal from the second UE during the first active duration based on activating the first active duration and in accordance with the configuration, and terminating the first active duration based on receiving the sidelink response.

An apparatus for wireless communications at a first UE is described. The apparatus may include a processor, memory coupled with the processor, and instructions stored in the memory. The instructions may be executable by the processor to cause the apparatus to receive a message indicating a configuration for a first active duration for the first UE, the first active duration being for a reversed communication direction during an active duration of a first discontinuous cycle for sidelink communications for the first UE, transmit, within the active duration of the first discontinuous cycle, a sidelink signal to a second UE, activate the first active duration based on transmitting the sidelink signal based on the configuration, switch from a transmission mode to a reception mode during the first active duration based on activating the first active duration, receive, based on switching from the transmission mode to the reception mode, a sidelink response to the sidelink signal from the second UE during the first active duration based on activating the first active duration and in accordance with the configuration, and terminate the first active duration based on receiving the sidelink response.

Another apparatus for wireless communications at a first UE is described. The apparatus may include means for receiving a message indicating a configuration for a first active duration for the first UE, the first active duration being for a reversed communication direction during an active duration of a first discontinuous cycle for sidelink communications for the first UE, means for transmitting, within the active duration of the first discontinuous cycle, a sidelink signal to a second UE, means for activating the first active duration based on transmitting the sidelink signal based on the configuration, means for switching from a transmission mode to a reception mode during the first active duration based on activating the first active duration, means for receiving, based on switching from the transmission mode to the reception mode, a sidelink response to the sidelink signal from the second UE during the first active duration based on activating the first active duration and in accordance with the configuration, and means for terminating the first active duration based on receiving the sidelink response.

A non-transitory computer-readable medium storing code for wireless communications at a first UE is described. The code may include instructions executable by a processor to receive a message indicating a configuration for a first active duration for the first UE, the first active duration being for a reversed communication direction during an active duration of a first discontinuous cycle for sidelink communications for the first UE, transmit, within the active duration of the first discontinuous cycle, a sidelink signal to a second UE, activate the first active duration based on transmitting the sidelink signal based on the configuration, switch from a transmission mode to a reception mode during the first active duration based on activating the first active duration, receive, based on switching from the transmission mode to the reception mode, a sidelink response to the sidelink signal from the second UE during the first active duration based on activating the first active duration and in accordance with the configuration, and terminate the first active duration based on receiving the sidelink response.

In some examples of the method, apparatuses, and non-transitory computer-readable medium described herein, the sidelink signal includes a triggering indication and the method, apparatuses, and non-transitory computer-readable medium may include further operations, features, means, or instructions for transmitting the sidelink signal during a first symbol or a first slot within the active duration of the first discontinuous cycle and activating the first active duration at a second symbol following the first symbol or slot or at a second slot following the first slot based on the transmitting.

In some examples of the method, apparatuses, and non-transitory computer-readable medium described herein, the triggering indication includes a channel state information request, a reference signal received power request, a channel busy ratio request, a beam request, or any combination thereof.

Some examples of the method, apparatuses, and non-transitory computer-readable medium described herein may further include operations, features, means, or instructions for switching from the reception mode to the transmission mode after the first active duration.

In some examples of the method, apparatuses, and non-transitory computer-readable medium described herein, a duration for the first active duration may be based on a latency value associated with the sidelink signal, the sidelink response, or both.

In some examples of the method, apparatuses, and non-transitory computer-readable medium described herein, the first active duration may be based on a reliability target associated with the sidelink signal or the sidelink response, a priority associated with the sidelink signal, the sidelink response, or both.

In some examples of the method, apparatuses, and non-transitory computer-readable medium described herein, activating the first active duration may include operations, features, means, or instructions for activating a first portion of the first active duration, the first portion including a duration for switching from the transmission mode to the reception mode and activating a second portion of the first active duration, the second portion including a duration for receiving the sidelink response to the sidelink signal during the first active duration.

In some examples of the method, apparatuses, and non-transitory computer-readable medium described herein, the second portion of the first active duration may be activated upon expiration of the first portion of the first active duration.

In some examples of the method, apparatuses, and non-transitory computer-readable medium described herein, the sidelink signal includes sidelink control information or a medium access control (MAC) control element (MAC-CE) and the sidelink response includes one or more media access control (MAC)-CEs.

Some examples of the method, apparatuses, and non-transitory computer-readable medium described herein may further include operations, features, means, or instructions for activating the first active duration includes activating a medium access control (MAC) control element (CE) timer.

In some examples of the method, apparatuses, and non-transitory computer-readable medium described herein, the sidelink signal and the sidelink response include one or more PC5 control messages and activating the first active duration includes activating a PC5 radio resource control (PCSRRC) timer or a sidelink timer.

Some examples of the method, apparatuses, and non-transitory computer-readable medium described herein may further include operations, features, means, or instructions for terminating the first active duration includes terminating a medium access control (MAC) control element (CE) timer, a PC5 radio resource control (PC5RRC) timer, or a sidelink timer.

Some examples of the method, apparatuses, and non-transitory computer-readable medium described herein may further include operations, features, means, or instructions for determining that the first active duration overlaps with a second active duration within an active duration of a second discontinuous cycle associated with the second UE and modifying the first active duration based on the determining.

Some examples of the method, apparatuses, and non-transitory computer-readable medium described herein may further include operations, features, means, or instructions for delaying activation of the first active duration within the active duration of the first discontinuous cycle based on the determining.

Some examples of the method, apparatuses, and non-transitory computer-readable medium described herein may further include operations, features, means, or instructions for terminating the first active duration at a beginning of the second active duration based on the determining.

Some examples of the method, apparatuses, and non-transitory computer-readable medium described herein may further include operations, features, means, or instructions for modifying the duration of the first active duration based on respective communication priorities associated with the first active duration and the second active duration.

A method for wireless communications at a first UE is described. The method may include receiving a message indicating a configuration for a first active duration for the first UE, the first active duration being for a reversed communication direction during an active duration of a first discontinuous cycle for sidelink communications for the first UE, receiving, within the active duration of the first discontinuous cycle, a sidelink signal from a second UE, activating the first active duration based on receiving the sidelink signal based on the configuration, switching from a reception mode to a transmission mode during the first active duration based on activating the first active duration, transmitting, based on switching from the reception mode to the transmission mode, a sidelink response to the sidelink signal from the second UE during the first active duration based on activating the first active duration and in accordance with the configuration, and terminating the first active duration based on transmitting the sidelink response.

An apparatus for wireless communications at a first UE is described. The apparatus may include a processor, memory coupled with the processor, and instructions stored in the memory. The instructions may be executable by the processor to cause the apparatus to receive a message indicating a configuration for a first active duration for the first UE, the first active duration being for a reversed communication direction during an active duration of a first discontinuous cycle for sidelink communications for the first UE, receive, within the active duration of the first discontinuous cycle, a sidelink signal from a second UE, activate the first active duration based on receiving the sidelink signal based on the configuration, switch from a reception mode to a transmission mode during the first active duration based on activating the first active duration, transmit, based on switching from the reception mode to the transmission mode, a sidelink response to the sidelink signal from the second UE during the first active duration based on activating the first active duration and in accordance with the configuration, and terminate the first active duration based on transmitting the sidelink response.

Another apparatus for wireless communications at a first UE is described. The apparatus may include means for receiving a message indicating a configuration for a first active duration for the first UE, the first active duration being for a reversed communication direction during an active duration of a first discontinuous cycle for sidelink communications for the first UE, means for receiving, within the active duration of the first discontinuous cycle, a sidelink signal from a second UE, means for activating the first active duration based on receiving the sidelink signal based on the configuration, means for switching from a reception mode to a transmission mode during the first active duration based on activating the first active duration, means for transmitting, based on switching from the reception mode to the transmission mode, a sidelink response to the sidelink signal from the second UE during the first active duration based on activating the first active duration and in accordance with the configuration, and means for terminating the first active duration based on transmitting the sidelink response.

A non-transitory computer-readable medium storing code for wireless communications at a first UE is described. The code may include instructions executable by a processor to receive a message indicating a configuration for a first active duration for the first UE, the first active duration being for a reversed communication direction during an active duration of a first discontinuous cycle for sidelink communications for the first UE, receive, within the active duration of the first discontinuous cycle, a sidelink signal from a second UE, activate the first active duration based on receiving the sidelink signal based on the configuration, switch from a reception mode to a transmission mode during the first active duration based on activating the first active duration, transmit, based on switching from the reception mode to the transmission mode, a sidelink response to the sidelink signal from the second UE during the first active duration based on activating the first active duration and in accordance with the configuration, and terminate the first active duration based on transmitting the sidelink response.

In some examples of the method, apparatuses, and non-transitory computer-readable medium described herein, the sidelink signal includes a triggering indication or a sidelink measurement reference signal and the method, apparatuses, and non-transitory computer-readable medium may include further operations, features, means, or instructions for receiving the sidelink signal during a first symbol or a first slot within the active duration of the first discontinuous cycle and activating the first active duration at a second symbol following the first symbol or slot or at a second slot following the first slot based on the receiving.

In some examples of the method, apparatuses, and non-transitory computer-readable medium described herein, the triggering indication includes a channel state information request, a reference signal received power request, a channel busy ratio request, a beam request, or any combination thereof.

Some examples of the method, apparatuses, and non-transitory computer-readable medium described herein may further include operations, features, means, or instructions for processing the sidelink signal within the first active duration and switching from the reception mode to the transmission mode during the first active duration, where the transmission mode includes sensing and resource selection for the sidelink signal.

In some examples of the method, apparatuses, and non-transitory computer-readable medium described herein, a duration for the first active duration may be based on a latency value associated with the sidelink signal, the sidelink response, or both.

In some examples of the method, apparatuses, and non-transitory computer-readable medium described herein, the first active duration may be based on a reliability target associated with the sidelink signal or the sidelink response, a priority associated with the sidelink signal or the sidelink response, or both.

In some examples of the method, apparatuses, and non-transitory computer-readable medium described herein, activating the first active duration may include operations, features, means, or instructions for activating a first portion of the first active duration, the first portion including a duration for switching from the reception mode to the transmission mode and activating a second portion of the first active duration, the second portion including a duration for transmitting the sidelink response to the sidelink signal during the first active duration.

In some examples of the method, apparatuses, and non-transitory computer-readable medium described herein, the second portion of the first active duration may be activated upon expiration of the first portion of the first active duration.

Some examples of the method, apparatuses, and non-transitory computer-readable medium described herein may further include operations, features, means, or instructions for switching from the transmission mode to the reception mode after the first active duration.

In some examples of the method, apparatuses, and non-transitory computer-readable medium described herein, the sidelink signal includes sidelink control information or a medium access control (MAC) control element (MAC-CE) and the sidelink response includes one or more MAC-CEs.

Some examples of the method, apparatuses, and non-transitory computer-readable medium described herein may further include operations, features, means, or instructions for activating the first active duration includes activating a medium access control (MAC) control element (CE) timer, a PC5 radio resource control (PC5RRC) timer, or a sidelink timer.

Some examples of the method, apparatuses, and non-transitory computer-readable medium described herein may further include operations, features, means, or instructions for terminating the first active duration includes terminating a medium access control (MAC) control element (CE) timer, a PC5 radio resource control (PC5RRC) timer, or a sidelink timer.

Some examples of the method, apparatuses, and non-transitory computer-readable medium described herein may further include operations, features, means, or instructions for determining that the first active duration overlaps with a second active duration within an active duration of a second discontinuous cycle associated with the second UE and modifying the first active duration based on the determining.

Some examples of the method, apparatuses, and non-transitory computer-readable medium described herein may further include operations, features, means, or instructions for delaying activation of the first active duration within the active duration of the first discontinuous cycle based on the determining.

Some examples of the method, apparatuses, and non-transitory computer-readable medium described herein may further include operations, features, means, or instructions for terminating the first active duration at the beginning of the second active duration based on the determining.

Some examples of the method, apparatuses, and non-transitory computer-readable medium described herein may further include operations, features, means, or instructions for modifying the duration of the first active duration based on respective communication priorities associated with the first active duration and the second active duration.

A method for wireless communications at a first UE is described. The method may include receiving a message indicating a configuration for a first timer for the first UE, the first timer for switching a communication direction during a first active duration of a discontinuous cycle for sidelink communications for the first UE, transmitting, within the first active duration of the discontinuous cycle, a sidelink signal to a second UE, activating the first timer based on transmitting the sidelink signal based on the configuration, switching from a transmission mode to a reception mode during the first active duration based on activating the first timer, receiving, based on switching from the transmission mode to the reception mode, a sidelink response to the sidelink signal from the second UE during the first active duration based on activating the first timer and in accordance with the configuration, and switching from the reception mode to the transmission mode during the first active duration based on receiving the sidelink response.

An apparatus for wireless communications at a first UE is described. The apparatus may include a processor, memory coupled with the processor, and instructions stored in the memory. The instructions may be executable by the processor to cause the apparatus to receive a message indicating a configuration for a first timer for the first UE, the first timer for switching a communication direction during a first active duration of a discontinuous cycle for sidelink communications for the first UE, transmit, within the first active duration of the discontinuous cycle, a sidelink signal to a second UE, activate the first timer based on transmitting the sidelink signal based on the configuration, switch from a transmission mode to a reception mode during the first active duration based on activating the first timer, receive, based on switching from the transmission mode to the reception mode, a sidelink response to the sidelink signal from the second UE during the first active duration based on activating the first timer and in accordance with the configuration, and switch from the reception mode to the transmission mode during the first active duration based on receiving the sidelink response.

Another apparatus for wireless communications at a first UE is described. The apparatus may include means for receiving a message indicating a configuration for a first timer for the first UE, the first timer for switching a communication direction during a first active duration of a discontinuous cycle for sidelink communications for the first UE, means for transmitting, within the first active duration of the discontinuous cycle, a sidelink signal to a second UE, means for activating the first timer based on transmitting the sidelink signal based on the configuration, means for switching from a transmission mode to a reception mode during the first active duration based on activating the first timer, means for receiving, based on switching from the transmission mode to the reception mode, a sidelink response to the sidelink signal from the second UE during the first active duration based on activating the first timer and in accordance with the configuration, and means for switching from the reception mode to the transmission mode during the first active duration based on receiving the sidelink response.

A non-transitory computer-readable medium storing code for wireless communications at a first UE is described. The code may include instructions executable by a processor to receive a message indicating a configuration for a first timer for the first UE, the first timer for switching a communication direction during a first active duration of a discontinuous cycle for sidelink communications for the first UE, transmit, within the first active duration of the discontinuous cycle, a sidelink signal to a second UE, activate the first timer based on transmitting the sidelink signal based on the configuration, switch from a transmission mode to a reception mode during the first active duration based on activating the first timer, receive, based on switching from the transmission mode to the reception mode, a sidelink response to the sidelink signal from the second UE during the first active duration based on activating the first timer and in accordance with the configuration, and switch from the reception mode to the transmission mode during the first active duration based on receiving the sidelink response.

In some examples of the method, apparatuses, and non-transitory computer-readable medium described herein, the sidelink signal includes a triggering indication and the method, apparatuses, and non-transitory computer-readable medium may include further operations, features, means, or instructions for transmitting the sidelink signal during a first symbol or a first slot within the first active duration and activating the first timer at a second symbol following the first slot or a second slot following the first slot based on the transmitting.

In some examples of the method, apparatuses, and non-transitory computer-readable medium described herein, the triggering indication includes a channel state information request, a reference signal received power request, a channel busy ratio request, a beam request, or any combination thereof.

Some examples of the method, apparatuses, and non-transitory computer-readable medium described herein may further include operations, features, means, or instructions for switching from the reception mode to the transmission mode during the first active duration, where the transmission mode includes sensing and resource selection for the sidelink signal.

In some examples of the method, apparatuses, and non-transitory computer-readable medium described herein, a duration for the first timer may be based on a latency value associated with the sidelink signal, the sidelink response, or both.

In some examples of the method, apparatuses, and non-transitory computer-readable medium described herein, the first timer may be based on a reliability target associated with the sidelink signal or the sidelink response, a priority associated with the sidelink signal, the sidelink response, or both.

In some examples of the method, apparatuses, and non-transitory computer-readable medium described herein, activating the first timer may include operations, features, means, or instructions for activating a first portion of the first timer, the first portion including a duration for switching from the transmission mode to the reception mode and activating a second portion of the first timer, the second portion including a duration for receiving the sidelink response to the sidelink signal during the first active duration.

In some examples of the method, apparatuses, and non-transitory computer-readable medium described herein, the second portion of the first timer may be activated upon expiration of the first portion of the first timer.

Some examples of the method, apparatuses, and non-transitory computer-readable medium described herein may further include operations, features, means, or instructions for deactivating the first timer and switching from the reception mode to the transmission mode during the first active duration and based on receiving the sidelink response.

In some examples of the method, apparatuses, and non-transitory computer-readable medium described herein, the sidelink signal includes sidelink control information or a medium access control (MAC) control element (MAC-CE) and the sidelink response includes one or more media access control MAC-CEs.

In some examples of the method, apparatuses, and non-transitory computer-readable medium described herein, the first timer includes a medium access control MAC-CE timer.

In some examples of the method, apparatuses, and non-transitory computer-readable medium described herein, the sidelink signal and the sidelink response include one or more PC5 control messages and the first timer includes a radio resource control (RRC) timer or a PC5 sidelink timer.

Some examples of the method, apparatuses, and non-transitory computer-readable medium described herein may further include operations, features, means, or instructions for determining that a duration associated with the first timer overlaps a duration associated with a second timer within a second active duration of a second discontinuous cycle associated with the second UE and modifying the duration of the first timer based on the determining.

Some examples of the method, apparatuses, and non-transitory computer-readable medium described herein may further include operations, features, means, or instructions for delaying activation of the first timer within the first active duration of the first discontinuous cycle based on the determining.

Some examples of the method, apparatuses, and non-transitory computer-readable medium described herein may further include operations, features, means, or instructions for terminating the first timer at the beginning of the second active duration based on the determining.

Some examples of the method, apparatuses, and non-transitory computer-readable medium described herein may further include operations, features, means, or instructions for modifying the duration of the first timer based on respective channel priorities associated with the first active duration and the second active duration.

A method for wireless communications at a first UE is described. The method may include receiving a message indicating a configuration for a first timer for the first UE, the first timer for switching a communication direction during a first active duration of a discontinuous cycle for sidelink communications for the first UE, receiving, within the first active duration of the discontinuous cycle, a sidelink signal from a second UE, activating the first timer based on receiving the sidelink signal based on the configuration, switching from a reception mode to a transmission mode during the first active duration based on activating the first timer, transmitting, based on switching from the reception mode to the transmission mode, a sidelink response to the sidelink signal from the second UE during the first active duration based on activating the first timer and in accordance with the configuration, and switching from the transmission mode to the reception mode during the first active duration based on transmitting the sidelink response.

An apparatus for wireless communications at a first UE is described. The apparatus may include a processor, memory coupled with the processor, and instructions stored in the memory. The instructions may be executable by the processor to cause the apparatus to receive a message indicating a configuration for a first timer for the first UE, the first timer for switching a communication direction during a first active duration of a discontinuous cycle for sidelink communications for the first UE, receive, within the first active duration of the discontinuous cycle, a sidelink signal from a second UE, activate the first timer based on receiving the sidelink signal based on the configuration, switch from a reception mode to a transmission mode during the first active duration based on activating the first timer, transmit, based on switching from the reception mode to the transmission mode, a sidelink response to the sidelink signal from the second UE during the first active duration based on activating the first timer and in accordance with the configuration, and switch from the transmission mode to the reception mode during the first active duration based on transmitting the sidelink response.

Another apparatus for wireless communications at a first UE is described. The apparatus may include means for receiving a message indicating a configuration for a first timer for the first UE, the first timer for switching a communication direction during a first active duration of a discontinuous cycle for sidelink communications for the first UE, means for receiving, within the first active duration of the discontinuous cycle, a sidelink signal from a second UE, means for activating the first timer based on receiving the sidelink signal based on the configuration, means for switching from a reception mode to a transmission mode during the first active duration based on activating the first timer, means for transmitting, based on switching from the reception mode to the transmission mode, a sidelink response to the sidelink signal from the second UE during the first active duration based on activating the first timer and in accordance with the configuration, and means for switching from the transmission mode to the reception mode during the first active duration based on transmitting the sidelink response.

A non-transitory computer-readable medium storing code for wireless communications at a first UE is described. The code may include instructions executable by a processor to receive a message indicating a configuration for a first timer for the first UE, the first timer for switching a communication direction during a first active duration of a discontinuous cycle for sidelink communications for the first UE, receive, within the first active duration of the discontinuous cycle, a sidelink signal from a second UE, activate the first timer based on receiving the sidelink signal based on the configuration, switch from a reception mode to a transmission mode during the first active duration based on activating the first timer, transmit, based on switching from the reception mode to the transmission mode, a sidelink response to the sidelink signal from the second UE during the first active duration based on activating the first timer and in accordance with the configuration, and switch from the transmission mode to the reception mode during the first active duration based on transmitting the sidelink response.

In some examples of the method, apparatuses, and non-transitory computer-readable medium described herein, the sidelink signal includes a triggering indication or a sidelink measurement reference signal and the method, apparatuses, and non-transitory computer-readable medium may include further operations, features, means, or instructions for receiving the sidelink signal during a first symbol or a first slot within the first active duration and activating the first timer at a second symbol following the first slot or a second slot following the first slot based on the receiving.

In some examples of the method, apparatuses, and non-transitory computer-readable medium described herein, the triggering indication includes a channel state information request, a reference signal received power request, a channel busy ratio request, a beam request, or any combination thereof.

Some examples of the method, apparatuses, and non-transitory computer-readable medium described herein may further include operations, features, means, or instructions for processing the sidelink signal within the first active duration and switching from the reception mode to the transmission mode during the first active duration, where the transmission mode includes sensing and resource selection for the sidelink signal.

In some examples of the method, apparatuses, and non-transitory computer-readable medium described herein, a duration for the first timer may be based on a latency value associated with the sidelink signal, the sidelink response, or both.

In some examples of the method, apparatuses, and non-transitory computer-readable medium described herein, the first timer may be based on a reliability target associated with the sidelink signal or the sidelink response, a priority associated with the sidelink signal or the sidelink response, or both.

In some examples of the method, apparatuses, and non-transitory computer-readable medium described herein, activating the first timer may include operations, features, means, or instructions for activating a first portion of the first timer, the first portion including a duration for switching from the reception mode to the transmission mode and activating a second portion of the first timer, the second portion including a duration for transmitting the sidelink response to the sidelink signal during the first active duration.

In some examples of the method, apparatuses, and non-transitory computer-readable medium described herein, the second portion of the first timer may be activated upon expiration of the first portion of the first timer.

Some examples of the method, apparatuses, and non-transitory computer-readable medium described herein may further include operations, features, means, or instructions for deactivating the first timer and switching from the transmission mode to the reception mode during the first active duration and based on transmitting the sidelink response.

In some examples of the method, apparatuses, and non-transitory computer-readable medium described herein, the sidelink signal includes sidelink control information or a medium access control (MAC) control element (MAC-CE) and the sidelink response includes one or more MAC-CEs.

In some examples of the method, apparatuses, and non-transitory computer-readable medium described herein, the first timer includes medium access control MAC-CE timer.

In some examples of the method, apparatuses, and non-transitory computer-readable medium described herein, the sidelink signal and the sidelink response include one or more PC5 control messages and the first timer includes an RRC timer or a PC5 sidelink timer.

Some examples of the method, apparatuses, and non-transitory computer-readable medium described herein may further include operations, features, means, or instructions for determining that a duration associated with the first timer overlaps a duration associated with a second timer within a second active duration of a second discontinuous cycle associated with the second UE and modifying the duration of the first timer based on the determining.

Some examples of the method, apparatuses, and non-transitory computer-readable medium described herein may further include operations, features, means, or instructions for delaying activation of the first timer within the first active duration of the first discontinuous cycle based on the determining.

Some examples of the method, apparatuses, and non-transitory computer-readable medium described herein may further include operations, features, means, or instructions for terminating the first timer at the beginning of the second active duration based on the determining.

Some examples of the method, apparatuses, and non-transitory computer-readable medium described herein may further include operations, features, means, or instructions for modifying the duration of the first timer based on respective channel priorities associated with the first active duration and the second active duration.

### BRIEF DESCRIPTION OF THE DRAWINGS

FIGS. 1 and 2 illustrate examples of wireless communications systems that support timer operations for directional sidelink discontinuous reception (DRX) in accordance with aspects of the present disclosure.

FIGS. 3A through 5C illustrate examples of resource diagrams that support timer operations for directional sidelink DRX in accordance with aspects of the present disclosure.

FIG. 6 illustrates an example of a process flow that supports timer operations for directional sidelink DRX in accordance with aspects of the present disclosure.

FIGS. 7 and 8 show block diagrams of devices that support timer operations for directional sidelink DRX in accordance with aspects of the present disclosure.

FIG. 9 shows a block diagram of a communications manager that supports timer operations for directional sidelink DRX in accordance with aspects of the present disclosure.

FIG. 10 shows a diagram of a system including a device that supports timer operations for directional sidelink DRX in accordance with aspects of the present disclosure.

FIGS. 11 through 17 show flowcharts illustrating methods that support timer operations for directional sidelink DRX in accordance with aspects of the present disclosure.

### DETAILED DESCRIPTION

In some wireless communications systems, a user equipment (UE) may communicate with another UE during an active duration (e.g., an ON duration) of a sidelink discontinuous cycle, such as a discontinuous reception (DRX) cycle. For a bidirectional DRX cycle, one or more UEs may share a DRX configuration and exchange one or more sidelink messages in both directions during the bidirectional ON duration of the DRX cycles. For a unidirectional DRX cycle or directional DRX cycle, each UE may be configured with a sidelink DRX. With a directional DRX cycle, a first UE may transmit in a transmission on (Tx-ON) duration or receive during a reception on (Rx-ON) duration. A second UE may receive or transmit accordingly during the unidirectional ON duration or unidirectional active duration of a directional sidelink DRX cycle for the first UE.

In some cases, the Tx-ON or Rx-ON duration of the directional DRX cycle for the first UE may not align with the Tx-ON or Rx-ON duration of the directional DRX cycle for the second UE, which may cause delayed responses to a control signal or a control message due to unidirectional communication within a directional ON duration. For example, the first UE may turn on during an Tx-ON duration of a directional DRX cycle to transmit a message to the second UE (e.g., in a transmission mode), but may not receive a response from the second UE until a subsequent Tx-ON duration of a directional DRX cycle for the second UE, in which the first UE has switched to a reception mode.

As described herein, a first UE and a second UE may receive pre-configuration message if out of network coverage or may receive a control message from a base station (e.g., network entity, network device, network node) if in network coverage or from a special UE such as an RSU, a group lead or a cluster lead in proximity where the pre-configuration or configuration message configures the UEs with one or more timers (e.g., a medium access control-control element (MAC-CE) timer or a radio resource control (RRC) PC5 timer) that the UEs may activate in order to switch communication directions within an ON duration of the sidelink DRX cycle. For example, the first UE may transmit (e.g., TX-ON is configured for its ON duration) an indication or message to the second UE to report or respond during a first directional ON duration (e.g., Tx-ON) of its directional DRX, and may switch from a transmission mode to a reception mode to monitor for a sidelink response from the second UE. Similarly, the second UE may receive the indication or message to report or respond during the ON duration (e.g., if a Tx-ON duration is configured for an ON duration of the transmitting UE) of the directional DRX cycle of the first UE, and the second UE may switch from a reception mode to a transmitting mode to transmit a sidelink response during the first directional ON duration. Upon receiving the sidelink response from the second UE, the first UE may deactivate the timer and switch back to a transmitting mode within the first directional ON duration, and the second UE may switch back to a receiving mode.

By enabling the UEs to switch communication directions multiple times during a single ON duration of a DRX cycle, latency caused by directional sidelink DRX may be reduced while increasing overall communications efficiency sidelink communications within the wireless network.

Aspects of the disclosure are initially described in the context of wireless communications systems. Aspects are then described with reference to resource diagrams, and a process flow. Aspects of the disclosure are further illustrated by and described with reference to apparatus diagrams, system diagrams, resource diagrams, a process flow, and flowcharts that relate to timer operations for directional sidelink DRX.

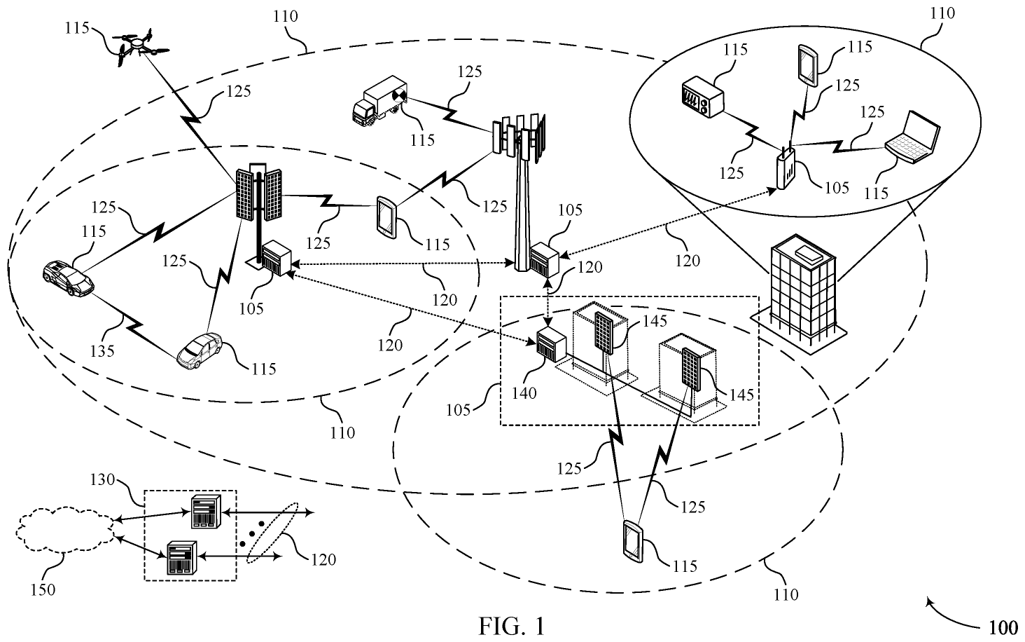

FIG. 1 illustrates an example of a wireless communications system 100 that supports timer operations for directional sidelink DRX in accordance with aspects of the present disclosure. The wireless communications system 100 may include one or more base stations 105 (e.g., network entity), one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology. In some examples, a base station 105 (e.g., network entity) may be implemented in a disaggregated architecture (e.g., a disaggregated base station architecture, a disaggregated RAN architecture), which may be configured to utilize a protocol stack that is physically or logically distributed among two or more base stations 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a base station 105 may include one or more of a central unit (CU), a distributed unit (DU), a radio unit (RU), a RAN Intelligent Controller (MC) (e.g., a Near-Real Time RIC (Near-RT MC), a Non-Real Time MC (Non-RT RIC)), a Service Management and Orchestration (SMO) system, or any combination thereof. An RU may also be referred to as a radio head, a smart radio head, a remote radio head (RRH), a remote radio unit (RRU), or a transmission reception point (TRP). One or more components of the base stations 105 in a disaggregated RAN architecture may be co-located, or one or more components of the base stations 105 may be located in distributed locations (e.g., separate physical locations). In some examples, one or more base stations 105 of a disaggregated RAN architecture may be implemented as virtual units (e.g., a virtual CU (VCU), a virtual DU (VDU), a virtual RU (VRU)).

The split of functionality between a CU, a DU, and an RU is flexible and may support different functionalities depending upon which functions (e.g., network layer functions, protocol layer functions, baseband functions, RF functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some examples, the CU may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as layer 1 (L1) (e.g., physical (PHY) layer) or L2 (e.g., radio link control (RLC) layer, MAC layer) functionality and signaling, and may each be at least partially controlled by the CU. Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some cases, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU). A CU may be functionally split further into CU control plane (CU-CP) and CU user plane (CU-UP) functions. A CU may be connected to one or more DUs via a midhaul communication link (e.g., Fl, Fl-c, Fl-u), and a DU may be connected to one or more RUs via a fronthaul communication link (e.g., open fronthaul (FH) interface). In some examples, a midhaul communication link or a fronthaul communication link may be implemented in accordance with an interface (e.g., a channel) between layers of a protocol stack supported by respective base stations 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network). In some cases, in an IAB network, one or more base stations 105 (e.g., IAB nodes) may be partially controlled by each other. One or more IAB nodes may be referred to as a donor entity or an IAB donor. One or more DUs or one or more RUs may be partially controlled by one or more CUs associated with a donor base station 105 (e.g., a donor base station). The one or more donor base stations 105 (e.g., IAB donors) may be in communication with one or more additional base stations 105 (e.g., IAB nodes) via supported access and backhaul links (e.g., backhaul communication links). IAB nodes may include an IAB mobile termination (IAB-MT) controlled (e.g., scheduled) by DUs of a coupled IAB donor. An IAB-MT may include an independent set of antennas for relay of communications with UEs 115, or may share the same antennas (e.g., of an RU) of an IAB node used for access via the DU of the IAB node (e.g., referred to as virtual IAB-MT (vIAB-MT)). In some examples, the IAB nodes may include DUs that support communication links with additional entities (e.g., IAB nodes, UEs 115) within the relay chain or configuration of the access network (e.g., downstream). In such cases, one or more components of the disaggregated RAN architecture (e.g., one or more IAB nodes or components of IAB nodes) may be configured to operate according to the techniques described herein.

In the case of the techniques described herein applied in the context of a disaggregated RAN architecture, one or more components of the disaggregated RAN architecture may be configured to support techniques for configuring communications based on unified TCI states as described herein. For example, some operations described as being performed by a UE 115 or a base station 105 (e.g., a network entity) may additionally, or alternatively, be performed by one or more components of the disaggregated RAN architecture (e.g., IAB nodes, DUs, CUs, RUs, RIC, SMO).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, or a vehicular device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D or PC5 protocol), also referred as a sidelink. One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system (e.g., multicast or groupcast) in which each UE 115 transmits to every other UE 115 in the group, where the group may be connection based (e.g., formed and managed by a group management function) or may be connectionless based (e.g., formed instantly based on communication range or distance). In some examples, a group communication may be managed by a group lead (e.g., a lead of a vehicle platooning) or a cluster head in proximity. In some examples, the UEs 115 communicating via D2D communications may utilize a one-to-one system (e.g., unicast) in which each UE 115 transmits to the other UE 115 with PC5 RRC connection. In some examples, the UEs 115 communicating via D2D communications may utilize a one-to-all system (e.g., broadcast) in which each UE 115 transmits to all other UE 115s within a communication range or in a proximity. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units (RSU), or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In wireless communications system 100, a UE 115 may communicate with another UE 115 during an ON (or active) duration of a sidelink discontinuous cycle, such as a DRX cycle or a discontinuous transmission (DTX) cycle. The UEs 115 may exchange one or more sidelink messages during the ON duration of their DRX or DTX cycles. In some cases, however, the DRX cycle supported by UEs 115 may be directional such that in some cases the ON duration of the directional discontinuous cycle may not align for both UEs 115, which may cause communication failure (e.g., when an ON duration of a UE 115 aligns with an OFF duration of another UE 115) or delayed responses to messages. Such directional traffic may introduce latency to the wireless system because a single UE 115 can either transmit or receive during the ON duration, and therefore may wait until the next ON duration to switch communication directions to either transmit a response or receive a sidelink message.

To reduce latency for DRX sidelink communications, a UE 115 may be pre-configured or configured to activate a timer within an active duration of the DRX cycle to switch communication directions within the single ON duration (e.g., without waiting until the next ON duration). The timer may be activated such that the UE 115 can switch from transmitting to receiving (or vice versa) more than one time during the ON duration. For example, a first UE 115 and a second UE 115 may receive a pre-configuration message (e.g., for out of network coverage) or may receive a control message from a base station 105 (e.g., for in-network coverage, via Uu RRC configuration) or from a special UE (e.g., an RSU, a group lead or a cluster lead, or a scheduling UE, via PC5 RRC configuration), where the pre-configuration or configuration message configures the UEs 115 with one or more timers, such as a MAC-CE timer or a PC5 timer. In a first example, the first UE 115 may transmit a sidelink message to the second UE 115 and the second UE 115 may receive and process the sidelink message during a first portion of an ON duration of the DRX cycle. Upon transmitting the sidelink message, the first UE 115 may start a timer for receiving a feedback from the second UE and the second UE 115 may start a timer for transmitting the feedback to the first UE. Within the timer duration and during the first ON duration, the first UE 115 may switch to a receiving mode and the second UE 115 may switch to a transmitting mode to transmit a feedback message to the first UE 115 within the ON duration. Upon receiving the feedback message from the second UE 115, and still within the ON duration, the first UE 115 may switch back to a transmitting mode, and the second UE 115 may switch back to a receiving mode.

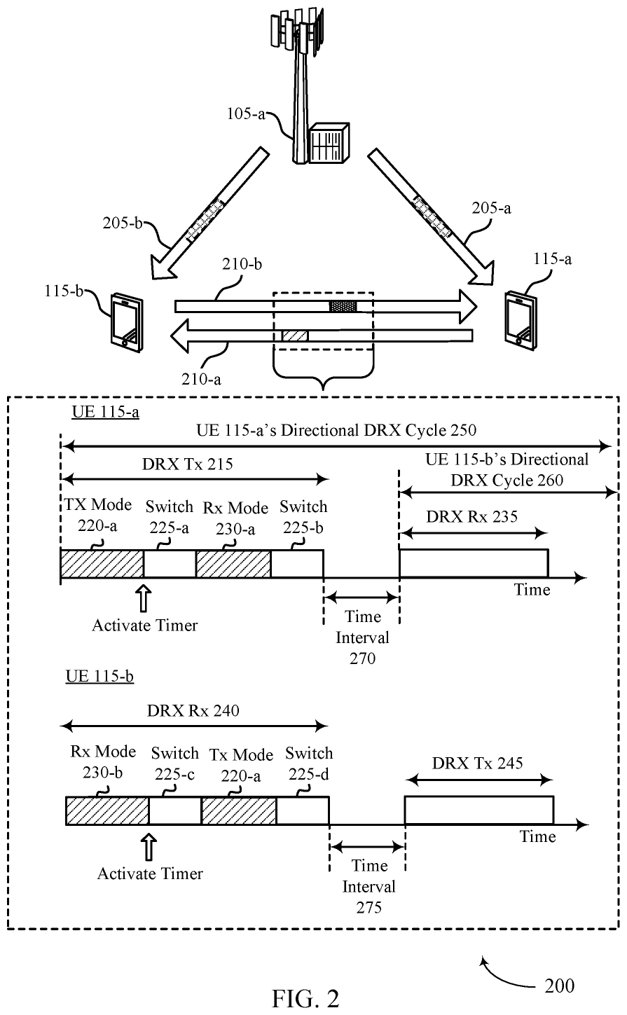

FIG. 2 illustrates an example of a wireless communication system 200 that supports timer operations for directional sidelink DRX in accordance with aspects of the present disclosure. In some examples, wireless communications system 200 may implement aspects of wireless communication system 100. For example, wireless communications system 200 may include UE 115-a, UE 115-b, and base station 105-a, which may be examples of UEs 115 and base station 105 as described with reference to FIG. 1. In some examples, base station 105-a and UE 115-a may transmit control signaling, data messages, or both using a direct communication link. For example, base station 105-a may transmit control signaling to UE 115-a, UE 115-b, or both via downlink communication links 205 (e.g., downlink communication link 205-a or downlink communication link 205-b). Similarly, in some cases, UE 115-a may communicate with another device, such as UE 115-b via a sidelink communication link 210. For example, UE 115-a may transmit control signaling or data messages to UE 115-b via sidelink communication link 210-a and UE 115-b may transmit control signaling or data messages to UE 115-a via sidelink communication link 210-b.

In some examples, UE 115-a may transmit a sidelink message via sidelink communication link 210-a to UE 115-b during an on-duration (e.g., a Tx-ON duration of UE 115-a) or active portion of a directional DRX cycle 250 for UE 115-a and UE 115-b may receive the sidelink message via sidelink communication link 210-a from UE 115-a during the on-duration (e.g., a Tx-ON duration of UE 115-a) or active portion of the directional DRX cycle 250 for UE 115-a. In some examples, UE 115-a may begin one or more timers within the active portion of the directional DRX cycle and may switch modes (e.g., from a transmission mode to a reception mode, or from a reception mode to a transmission mode) to communicate via sidelink communications with UE 115-b, and in the same active portion, the UE 115-a may switch modes again within the duration of the timer. In some examples, UE 115-a and UE 115-b may be out of a coverage area for a base station 105, and may be preconfigured with the timers, or the timers may be configured using configuration signaling from the base station 105-a if in a coverage area of the base station 105-a. The timers in some examples may be maintained separately by each UE 115 (e.g., the UE 115-a may maintain a first timer, and the UE 115-b may maintain a second timer) with common values (e.g., the timer for switching the communication direction based on UE's capability, the timer for response based on latency requirement) preconfigured or configured for both UEs.

In some examples, a base station 105 and a UE 115 may communicate using an RRC protocol. For example, UE 115-a and UE 115-b may operate in various RRC states, such as an RRC connected state, an RRC inactive state, an RRC idle state, or a combination thereof. In addition, UE 115-a and UE 115-b may communicate using sidelink communication links 210-a or sidelink communication link 210-b, via a PC5-RRC protocol (e.g., a sidelink RRC protocol). In some cases, a PC5-RRC procedure may be designed per direction, and UEs 115 may implement directional sidelink communications. For example, UE 115-a may send PC5-RRC configuration signaling to UE 115-b (e.g., a UE 115-a to UE 115-b direction) while operating in a transmission mode (e.g., within directional DRX cycle 250). Additionally, or alternatively, the UE 115-a may receive PC5-RRC configuration signaling from the UE 115-b while operating in a receiving mode (e.g., UE 115-b to UE 115-a direction with directional DRX cycle 260).

In some cases, such as when UE 115-a and UE 115-b are in the RRC idle or RRC inactive state, UE 115-a and UE 115-b may communicate one or more messages with base station 105-a or another UEs 115 according to a DRX cycle with the base station 105-a via a Uu interface (e.g., Uu DRX cycle not shown in FIG. 2) or a sidelink DRX cycle on PC5 interface, respectively. The sidelink DRX cycle may be directional depending on communication direction for the UE 115-a or UE 115-b and may be referred to as a directional sidelink DRX for sidelink communications (e.g., between UE 115-a and UE 115-b). For example, if the UE 115 is in a transmission mode during its ON duration (e.g., within directional DRX cycle 250), the directional DRX may be a Tx-ON duration. If the UE 115 is in a reception mode during its ON duration, and the directional DRX cycle may be an Rx-ON duration (e.g., within directional DRX cycle 260). Each sidelink DRX cycle (e.g., directional DRX cycle 250 and 260) may have an ON duration during which the UE 115 (e.g., UE 115-a and UE 115-b) is awake for transmitting (e.g., configured with Tx-ON) or receiving (e.g., configured with Rx-ON) and an inactive duration in which UE 115 (e.g., UE 115-a and UE 115-b) is in a reduced power mode (e.g., a sleep mode) to reduce power consumption.

In some examples, the periodicity of each sidelink DRX cycle (e.g., directional DRX cycle 250 and 260), which may be a directional DRX cycle, as well as the ON duration and inactive duration may be configured by the base station 105-a, may be identified by the UE 115 via a configuration, or may be otherwise signaled to the UE 115 by another UE 115. For example, base station 105-a may transmit control signaling, such as RRC signaling, a downlink control information (DCI) message, a MAC-CE, or other messaging to UE 115-a, UE 115-b, or both, if within a coverage area for base statin 105-a. The control signaling may include a sidelink DRX configuration, such as a timer configuration, which may include an indication of one or more parameters for the directional sidelink DRX cycle at each UE 115 (e.g., sidelink DRX Cycle length, sidelink DRX offset for starting point of ON duration, sidelink DRX ON duration, sidelink inactivity timer and/or HARQ related timers for extending active state, sidelink DRX timers for switching communication direction, etc.). The timer configuration 215 may include a timer that indicates to UE 115-a when to initiate a switching for communication direction, for example, from transmission mode to reception mode during the Tx-ON duration 215 of its directional sidelink DRX cycle. The control information may also include information regarding this directional sidelink DRX cycles for surrounding UEs 115, such as UE 115-b. Similarly, the timer configuration may include a timer that indicates to UE 115-b when to initiate a switching for communication direction, for example, from reception mode to transmission mode during the Rx-ON duration 215 of a directional sidelink DRX cycle 215 for UE 115-a, for example, depending on directional sidelink DRX cycles for other sidelink UEs (e.g., directional DRX cycle 250 and 260). That is, if UE 115-a enters a reception mode, UE 115-b may enter a transmission mode such that the ON duration of each DRX cycle may align for directional communications on a sidelink communication link 210, which may be a unicast link.

Additionally, or alternatively, if UE 115-a enters a reception mode (e.g., with Rx-ON configured for ON duration), UE 115-b may enter a transmission mode such that the ON duration 225 of each cycle may align. Thus, base station 105-a may configure a pair of source and destination UEs 115 with directional sidelink DRX cycles that may be either transmission centric (e.g., based on Tx-ON of UE 115's directional sidelink DRX) or reception centric (e.g., based on Rx-ON of the UE 115's directional sidelink DRX). In some examples, the base station may determine a directional sidelink DRX configuration with transmission centric or reception centric and the associated timer based on UE 115's assistance information, such as suitable direction (e.g., Tx-ON or Rx-ON) and suitable value(s) for ON duration, suitable value(s) for timer(s), suitable value(s) for directional sidelink DRX cycle length(s), etc.

In some examples, if the base station 105-a configures one or more UEs 115 with a discontinuous cycle, such as a directional sidelink DRX cycle (e.g., directional DRX cycle 250 or 260 with Tx-ON or Rx-ON for ON duration, respectively), and/or if a UE 115 transmits or receives during an ON duration or active duration 215 (e.g., UE 115-a may transmit during DRX Tx period 215), the UE 115 may switch to the other direction to receive or transmit a response, respectively, based on the timer activated. For example, in some cases if UE 115-a transmits a message to UE 115-b during its ON duration 215 of directional DRX cycle 250, the UE 115-a may not receive a response from UE 115-b until entering a reception mode at an ON duration 235 of directional DRX cycle 260 (e.g., Tx-ON configured for UE 115-b), and UE 115-b may not respond until entering transmission mode 245 (e.g., Tx-ON configured for UE 115-b) of UE 115-b's directional sidelink DRX cycle 260. Thus, the time interval between the two directional ON durations (e.g., the time interval 270 between Tx-ON duration 215 and Rx-ON duration 235 for UE 115-a and the time interval 275 between Rx-ON duration 240 and Tx-ON duration 245 for UE 115-b) may cause a delay between an original message or signal and a responding message or signal, which may cause performance degradation or even failure for sidelink control signal or message exchanges.

In some examples, UE 115-a and UE 115-b may be configured with a timer, such that UE 115-a and UE 115-b may switch directions for a communication mode for the duration while the timer is running which may be within a directional ON duration of a directional sidelink DRX cycle. For example, UE 115-a and UE 115-b may be preconfigured, or configured by base station 105-a with a sidelink DRX configuration or a timer configuration via downlink communication link 205-a and downlink communication link 205-b, respectively. In some examples, the sidelink DRX or timer configuration may include a timer for directional DRX cycle length, an offset timer for starting a directional sidelink DRX cycle (e.g., the timer for starting ON duration or active duration 215 and 240), a timer for ON duration or active state, an inactivity timer and/or HARQ-related timers for extending active state, an RTT (round trip time) timer for switching the direction of a communication mode at 225-a, 225-b, 225-c, and 225-d, an active timer for transmitting or receiving a response signal during a reception mode or a transmission mode respectively, or combination of any. If the timer configuration includes the timer for switching the direction of a communication mode, UE 115-a, UE 115-b, or both may perform the switching operation during the ON duration 225 of a directional sidelink DRX cycle (e.g., directional DRX cycle 250 or 260). In some other examples, an activated timer of a first DRX ON duration (e.g., within directional DRX cycle 250) may overlap with a second timer of a second DRX ON duration (e.g., within directional DRX 260) for a UE 115. In such cases, the UE 115 may identify the overlap and delay or deactivate the timer to avoid the overlap.

In some cases, UE 115-a may operate in a Tx-centric configuration. The UE 115-a may enter the DRX ON duration 215, which may include a transmitting mode 220-a (e.g., Tx-ON). UE 115-a may transmit a sidelink signal or message during the Tx ON duration 220-a. For example, UE 115-a may transmit the sidelink signal or message to UE 115-b via sidelink communication link 210-a. In some examples, rather than waiting to switch to a receive mode during DRX Rx duration 235 within directional DRX cycle 260, UE 115-a may activate a timer after transmitting the sidelink message to switch (e.g., at 225-a) to an Rx mode 230-a to monitor for the response from UE 115-b. Upon receiving a sidelink response from the UE 115-b during the Rx mode 230-a, the UE 115-a may switch back to the Tx mode at 225-b. In some examples, the UE 115-a may switch once or multiple times from the Tx mode 220-a to the Rx mode 230-a and back to the Tx mode within the single DRX Tx duration 215. The UE 115-a may then begin a DRX Rx duration at 235 within directional DRX cycle 260.

In some cases, the UE 115-b may operate in an Rx-centric configuration. UE 115-b may enter DRX ON duration 240 within directional DRX cycle 250, and may operate in accordance with Rx mode 230-b to receive a sidelink message from UE 115-a. The UE 115-b may activate a timer, and may switch to a transmission mode 220-a to transmit a response to the UE 115-a based on processing the sidelink message received from the UE 115-b. Upon transmitting the sidelink response to UE 115-a during the Tx mode 220-a, the UE 115-b may switch back to the Rx mode at 225-d. In some examples, the UE 115-b may switch one or more times from the Rx mode 230-a to the Tx mode 220-a and back to the Tx mode within the single DRX Rx duration 215. The UE 115-b may then begin a DRX Tx duration at 245.

In some examples, the sidelink feedback or response message may be a MAC-CE or an PC5 RRC message, and the UEs 115 may be configured with timers corresponding to the latency requirement associated with a MAC-CE or a PC5 RRC response (e.g., a MAC-CE timer or a PC5 RRC timer based on the latency). For example, a receiving UE may process and transmit a feedback message in the sidelink response based on the latency requirement for a MAC-CE response. In such cases, UE 115-a and UE 115-b may start a MAC-CE timer respectively based on the latency for communicating the MAC-CE. In some other examples, the sidelink message may include one or more RRC messages, such as a PC5-RCC message. A UE 115 may process and transmit a feedback message to UE 115 in the sidelink response. For example, UE 115-a and UE 115-b may start a PC5 timer respectively based on the latency for communicating the RRC messages. In some cases, UE 115-a, UE 115-b, or both may enable or disable a timer based on providing feedback for the sidelink response or an acknowledgment. In some examples, a timer may be configured based on different QoS flows, such as latency or packet delay budget, reliability, or priority associated with the MAC-CE or a logical channel carrying the PC5 RRC messages. In addition, a timer may be enabled or disabled based on if a sidelink feedback or response is to be sent.

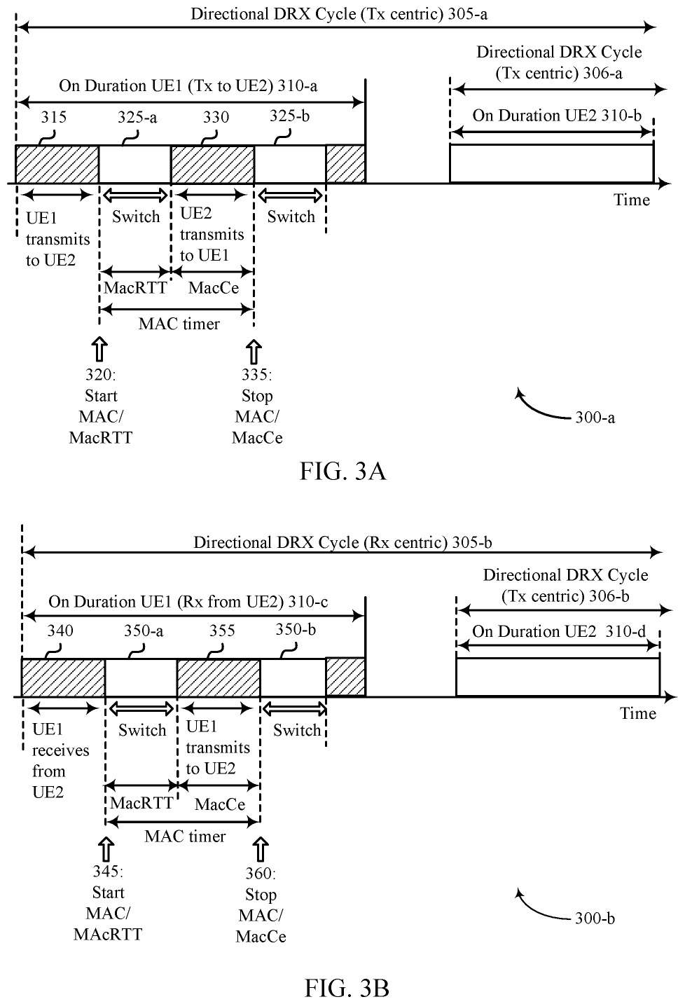

FIGS. 3A and 3B illustrate example resource diagrams 300 that support timer operations for directional sidelink DRX in accordance with aspects of the present disclosure. In some examples, resource diagram 300-a and resource diagram 300-b may implement aspects of wireless communication system 100 and wireless communications system 200. For example, sidelink directional DRX diagram 300-a and sidelink directional DRX diagram 300-b may be implemented by one or more UEs 115 in sidelink communication as described with reference to FIGS. 1 and 2. In some cases, a base station may transmit control signaling to the one or more UEs including a sidelink DRX configuration or a timer configuration for a discontinuous cycle 305 (e.g., a DRX cycle 305-a and a DRX cycle 305-b) and/or for a discontinuous cycle 306 (e.g., a DRX cycle 306-a and a DRX cycle 306-b), such that the UEs may switch operation direction during an active duration of the directional DRX cycle 305 or 306. In some examples, as illustrated in FIG. 3A, a UE (e.g., UE1) may switch from a transmission mode 315 to a reception mode 330 for receiving a sidelink response from another UE (e.g., UE2). Additionally, or alternatively, as illustrated in FIG. 3B, the UE (e.g., UE1) may switch from a reception mode 340 after receiving a sidelink message to a transmission mode 355 for transmitting a sidelink response to another UE (e.g., UE2).

In some examples, a UE may operate according to a DRX cycle 305 or 306. For example, a base station may configure a UE with a discontinuous cycle 305 or 306 with an active duration 310-a or 310-b, respectively (e.g., for transmitting and receiving sidelink transmissions) and an inactive duration (e.g., for remaining in an inactive or low-power state). The discontinuous cycle 305 or 306 may be directional (e.g., in a reception direction with Rx-ON or a transmission direction with Tx-ON) and may be periodic. For example, as illustrated in FIG. 3A, the UE may be configured for Tx-centric sidelink DRX, in which the UE may implement a timer for switching between Tx and Rx modes for communicating MAC signaling during the directional DRX cycle.

For example, FIG. 3A may support sidelink communications which include MAC-CE based controlling or reporting operations (e.g., an acknowledgment related to an activation or deactivation MAC-CE, a channel state information (CSI) report on a MAC-CE, an RSRP or CBR measurement reported on a MAC-CE, a buffer status report on a MAC-CE, a beam measurement report or beam failure report on a MAC-CE, a resource report or response on a MAC-CE, an LBT information report on a MAC-CE, etc.), which may operate in accordance with certain latency targets. To enable bi-directional controlling or reporting operations within a required latency, a UE may start one (e.g., a MAC timer) or more timers (e.g., MacRTT timer and MacCe timer) during a directional ON duration to switch the communication direction (e.g., from transmitting to receiving, and receiving to transmitting) for a report or response on a MAC-CE.

In an example of Tx-centric sidelink DRX in FIG. 3A, the UE (e.g., UE1) may start a timer (e.g., a MAC timer or MacRTT timer) for switching communication directions within the directional ON duration 310-a. In such examples, the receiving UE (e.g., UE2) may transmit one or more MAC-CE based feedback or report messages (e.g., response to activation or deactivation for resource or resource pool(s), carrier component(s) or sidelink BWP, beam management report, CSI reporting, RSRP or CBR reporting, buffer status report, or a combination thereof) to UE1 within a required latency or reduced latency relative to a latency incurred by transmitting the MAC-CE response at the next ON duration 310-b).

The UE1 may transmit sidelink packets and/or measurement signals (e.g., sidelink CSI RS, sidelink phase tracking (TP) reference signals, or sidelink DMRS, etc.) and/or one or more triggering indications for reporting or feedback indicated in one or more SCIs (e.g., CSI request in SCI 2) or MAC-CEs (e.g., resource request, RSRP request, beam request, LBT information request, etc.), to the UE2 during the directional DRX ON duration 310-a and during its Tx period 315, and UE2 may receive the packets and collect sidelink measurements (e.g., CSI measurements, channel busy ratio (CBR) measurements, reference signal receive power (RSRP) measurements, beam measurements, etc.) based on the measurements signals and the trigger indication(s) for report or feedback received from the UE1 during its Rx period of ON duration 310-a.

To meet a latency requirement of the sidelink communications between the UE1 and UE2, the UE1 may start a timer (e.g., a MAC timer based on the latency requirement or a MacRTT timer based on UE's communication direction switching) at a first symbol or slot 320 after transmitting the sidelink message and/or measurement signal(s) or the triggering indication(s) to the UE2. In some examples, the trigger indication(s) may be a CSI Request, RSRP Request, CBR Request, Beam Report Request (e.g., beam measurement or beam switching), Resource Request, LBT information request (e.g., LBT success or failure rate, consecutive LBT failure count, etc.), etc. indicated in SCI2 or MAC-CE. Based on starting the timer (e.g., MAC timer or MAC RTT timer), the UE1 may switch at 325-a from a Tx mode to an Rx mode. In some implementations, the timer may include two portions, a MacRTT timer for switching a communication direction, and a MacCe timer for monitoring the feedback or response on MAC-CE(s), where the MacCe timer is automatically activated when the MacRTT timer expires. In some cases, the timer(s) (e.g., the duration of MAC timer or the combined duration of MacRTT timer and MacCe timer) may be bounded by a latency target for the MAC-CE(s) (e.g., sl-CSI-ReportTimer for CSI report). The sensing and resource selection for transmitting the MAC-CE(s) to UE1 may be conducted within 325-a (e.g., MacRTT timer) or 330 (e.g., MacCe timer) based on different sensing and resource selection schemes at the receiver side (e.g., long or short sensing for resource selection, random resource selection without sensing at an Rx UE). In some cases, UE1 may be in an inactive state for sidelink communications while MacRTT timer is running.

In some examples, the UE2 may start a timer (e.g., a MAC timer based on the latency requirement or a MacRTT timer based on communication direction switching) at the first symbol or slot 320 after receiving one or more sidelink messages and/or measurement signals or the triggering indications (e.g., by decoding SCI2 or MAC-CE). While the timer is running (e.g., during the duration of MAC timer), the UE2 may process the sidelink measurement and may switch to transmitting mode at 325-a and transmit the feedback or report at 330. In some implementations, the timer may include two portions, a MacRTT timer for switching communication direction and a MacCe timer for transmitting the feedback or response on MAC-CE(s), where MacCe timer is automatically activated when the MacRTT timer expires. In some cases, the timer(s) (e.g., the duration of MAC timer or the combined duration of MacRTT timer and MacCe timer) may be bounded by a latency target for the MAC-CE(s) (e.g., sl-CSI-ReportTimer for CSI report). The sensing and resource selection for transmitting the MAC-CE(s) to UE1 may be conducted within 325-a or 330 based different sensing and resource selection schemes at the transmitter side (e.g., long or short sensing for resource selection, random resource selection without sensing at a Tx UE). In some cases, the UE2 may be in an inactive state for sidelink communications while MacRTT timer is running.

While the timer is running (e.g., during the duration of MAC timer or MacCe timer) for feedback or response, the UE2 may transmit, and the UE1 may monitor for and receive one or more MAC-CEs for one or more feedbacks or responses. In some examples, the UE2 may stop the timer (e.g., MAC timer or the MacCe timer) at the first symbol or slot 335 after transmitting the one or more MAC-CEs to end the duration of transmitting feedback or response messages with MAC-CE(s), and the UE2 may and switch back to the Rx mode at 325-b within the ON duration 310-a. The UE1 may stop the timer (e.g., MAC timer or MacCe timer) at the first symbol or slot 335 after receiving the one or more MAC-CEs to end the duration of receiving feedback or response messages with MAC-CE(s) and may switch back to the Tx mode at 325-b within the ON duration 310-a. UE1 or UE2 may be in an active state for reversed direction communications (e.g., receiving or transmitting feedback or report messages) on sidelink while MAC timer or MacCe timer is running.

In an example of Rx-centric sidelink DRX in FIG. 3B, the UE (e.g., UE1) may start a timer (e.g., a MAC timer or MacRTT timer) for switching communication directions within the directional ON duration 310-c. In such examples, the transmitting UE (e.g., UE2) may transmit one or more triggering indications (e.g., activation or deactivation for resource or resource pool(s), carrier component(s) or sidelink BWP, beam management report, CSI reporting, RSRP or CBR measurement report, or a combination thereof) to UE1 within a required latency (or reduced latency relative to a latency incurred by receiving the MAC-CE at the next ON duration 310-d of directional DRX cycle 306-b).

The UE2 may transmit sidelink packets or measurement signals (e.g., sidelink CSI RS, sidelink TPRS, or sidelink DMRS, etc.) and/or one or more triggering indications for report or feedback indicated in one or more SCIs (e.g., CSI request in SCI 2) or MAC-CEs (e.g., resource request, RSRP request, beam request, LBT information request, etc.) during the directional DRX ON duration 310-c and during the Rx period 340 for UE1, and UE1 may receive the packets and collect sidelink measurements (e.g., CSI measurements, CBR measurements, RSRP measurements, beam measurements, etc.) based on the measurements signals and the triggering indication(s) for report or feedback received from the UE2 during the Rx period 340 within ON duration 310-c.

To meet latency requirements of the sidelink communications between the UE1 and UE2, the UE1 may start a timer (e.g., a MAC timer based on the latency requirements or a MacRTT timer based on UE's communication direction switching) at the first symbol or slot 345 after receiving the sidelink message and/or measurement signal(s) or the triggering indication(s) from the UE2. In some examples, the triggering indication(s) message may be a CSI Request, RSRP Request, CBR Request, Beam Report Request (e.g., beam measurement or beam switching), Resource Request, LBT Information Request (e.g., LBT success or failure rate, consecutive LBT failure count, etc.), etc. indicated in SCI2 or MAC-CE. In some cases, the UE1 may start the timer (e.g., MAC timer or MAC RTT timer) at the first symbol or slot 345 after receiving the sidelink measurement signal and/or the triggering indication (s) from the UE2. Based on starting the timer, the UE1 may switch at 350-a from an Rx mode to a Tx mode. In some implementations, the timer may include two portions, a MacRTT timer for switching communication direction and a MacCe timer for monitoring the feedback or response on MAC-CE(s), where MacCe timer is automatically activated when the MacRTT timer expires. In some cases, the timer(s) (e.g., the duration of MAC timer or the combined duration of MacRTT timer and MacCe timer) may be bounded by a latency target for the MAC-CE(s) (e.g., sl-CSI-ReportTimer for CSI report). The sensing and resource selection for transmitting the MAC-CE(s) to UE2 may be conducted within 350-a (e.g., MacRTT timer) or 355 (e.g., MacCe timer) based different sensing and resource selection schemes at the transmitter side (e.g., long or short sensing for resource selection, random resource selection without sensing at a Tx UE). UE1 is inactive state for sidelink communications while MacRTT timer is running.

In some examples, the UE2 may start a timer (e.g., a MAC timer based on the latency requirement or a MacRTT timer based on communication direction switching) at the first symbol or slot 345 after transmitting the sidelink message and/or measurement signal(s) or the triggering indication(s) (e.g., SCI2 or MAC-CE). While the timer is running (e.g., during the duration of MAC timer), the UE2 may switch to a receiving mode at 350-a and monitor and receive the feedback or report at 355. In some implementations, the timer may include two portions, a MacRTT timer for switching communication direction and a MacCe timer for transmitting the feedback or response on MAC-CE(s), where MacCe timer is automatically activated when the MacRTT timer expires. In some cases, the timer(s) (e.g., the duration of MAC timer or the combined duration of MacRTT timer and MacCe timer) may be bounded by a latency target for the MAC-CE(s) (e.g., sl-CSI-ReportTimer for CSI report). The sensing and resource selection for transmitting the MAC-CE(s) to UE1 may be conducted within 350-a or 355 based different sensing and resource selection schemes at the receiver side (e.g., long or short sensing for resource selection, random resource selection without sensing at an Rx UE). In some examples, the UE2 may be in an inactive state for sidelink communications while MacRTT timer is running.

While the timer is running (e.g., during the duration of MAC timer or MacCe timer) for feedback or response, the UE1 may transmit, and the UE2 may monitor for and receive one or more MAC-CEs for one or more feedback or response messages. In some examples, the UE1 may stop the timer (e.g., the MAC timer or MacCe timer) at the first symbol or slot 360 after transmitting the one or more MAC-CEs to end the duration of transmitting feedback or responses with MAC-CE(s), and the UE1 may switch back to the Rx mode at 350-b within the ON duration 310-c. The UE2 may stop the timer (e.g., the MAC timer or MacCe timer) at the first symbol or slot 360 after receiving the one or more MAC-CEs to end the duration of receiving feedback or response messages and may switch back to the Tx mode at 350-b within the ON duration 310-c. UE1 or UE2 may be in an active state for reversed direction communications (e.g., transmitting or receiving feedback or report messages) on sidelink while MAC timer or MacCe timer is running.

In some cases, the timer (e.g., the duration of MAC timer or the combined duration of MacRTT timer and MacCe timer) may be bounded by the minimum latency requirement of multiple latency requirements or by the latency requirement of the MAC-CE with highest priority if multiple MAC-CEs are multiplexed into one feedback or response transmission.

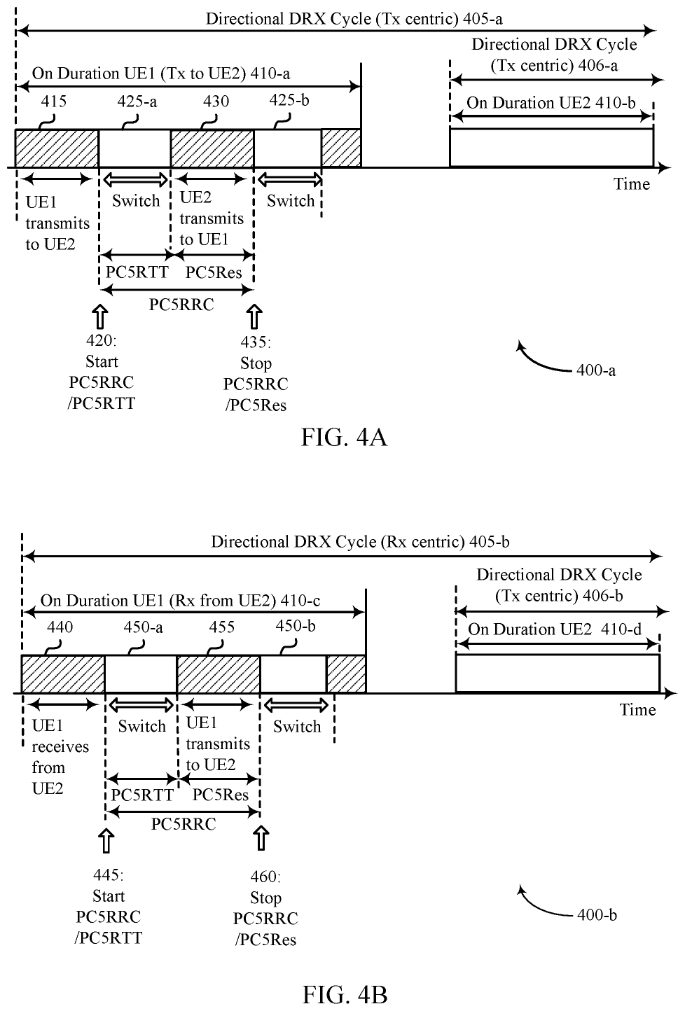

FIGS. 4A and 4B illustrate example resource diagrams 400 that support timer operations for directional sidelink DRX in accordance with aspects of the present disclosure. In some examples, resource diagram 400-a and resource diagram 400-b may implement aspects of wireless communication system 100 and wireless communications system 200. For example, sidelink directional DRX diagrams 400-a and sidelink directional DRX diagram 400-b may be implemented by one or more UEs 115 in sidelink communication as described with reference to FIGS. 1 and 2. In some cases, a base station may transmit control signaling to the one or more UEs including a sidelink DRX configuration or a timer configuration for a discontinuous cycle 405 (e.g., a DRX cycle 405-a and a DRX cycle 405-b) and/or for a discontinuous cycle 406 (e.g., a DRX cycle 406-a and a DRX cycle 406-b), such that the UEs may switch operation direction during an active duration of the directional DRX cycle 405 or 406. In some examples, as illustrated in FIG. 4A, a UE (e.g., UE1) may switch from a transmission mode 415 to a reception mode 430 for receiving a sidelink response from another UE (e.g., UE2). Additionally, or alternatively, as illustrated in FIG. 4B, the UE (e.g., UE1) may switch from a reception mode 440 after receiving a sidelink message to a transmission mode 455 for transmitting a sidelink response to another UE (e.g., UE2).

In some examples, a UE may operate according to a DRX cycle 405 or 406. For example, a base station may configure a UE with a discontinuous cycle 405 or 406 with an active duration 410-a or 410-b respectively (e.g., for transmitting and receiving sidelink transmissions) and an inactive duration (e.g., for remaining in an inactive or low-power state). The discontinuous cycle 405 or 406 may be directional (e.g., in a reception direction with Rx-ON or a transmission direction with Tx-ON) and may be periodic. For example, as illustrated in FIG. 4A, the UE may be configured for Tx-centric sidelink DRX, in which the UE may implement a timer for switching between Tx and Rx modes for communicating PC5 RRC type signaling during the directional DRX cycle.

For example, FIG. 4A may support sidelink communications which include PC5 signaling (PC5-S) messages such as Direct Communication Request/Accept, Link Identifier Update Request/Response/Ack, Disconnect Request/Response, Link Modification Request/Accept, Keep-alive/Ack, or PC5 RRC configuration messages such as RRCReconfigurationSidelink/RRCReconfigurationCompleteSidelink, or RRCReconfigurationFailureSidelink. To enable PC5-S and/or PC5 RRC message exchange within required latency, a UE may start one or more timers (e.g., PC5RRC timer, PC5RTT timer and PC5Res timer) during a directional ON duration to switch the communication direction (e.g., from transmitting to receiving, and receiving to transmitting).

In an example of Tx-centric sidelink DRX in FIG. 4A, the UE (e.g., UE1) may start a timer (e.g., a PC5RRC timer or PC5RTT timer) for switching communication directions within the directional ON duration 410-a. In such examples, the receiving UE (e.g., UE2) may transmit one or more PC5 RRC responding messages to UE1 within a required latency or reduced latency relative to a latency incurred by receiving the PC5 RRC responding message at the next ON duration 410-b).

The UE1 may transmit one or more PC5-S messages (e.g., Direct Communication Request, Link Identifier Update Request, Disconnect Request, Link Modification Request, Keep-alive) or one or more PC5 RRC configuration messages (e.g., RRCReconfigurationSidelink), to the UE2 during the directional DRX ON duration 410-a and during its Tx period 415, and UE2 may receive the PC5-S message(s) or PC5 RRC configuration message(s) from the UE1 during its Rx period 415 of ON duration 410-a.

To meet a latency requirement of the PC5-S or PC5 RRC configuration messages between the UE1 and UE2, the UE1 may start a timer (e.g., a PC5RRC timer based on the latency requirement or a PC5RTT timer based on UE's communication direction switching) at a first symbol or slot 420 after transmitting the PC5-S or PC5 RRC message to the UE2. Based on starting the timer (e.g., PC5RRC timer or PC5RTT timer), the UE1 may switch at 425-a from a Tx mode to an Rx mode. In some examples, the timer may include two portions, a PC5RTT timer for switching communication directions and a PC5Res timer for monitoring the PC5-S or PC5 RRC response messages, where the PC5Res timer may be automatically activated when the PC5RTT timer expires. In some cases, the timer (e.g., the duration of PC5RRC timer or the combined duration of PC5RTT timer and PC5Res timer) may be bounded by a latency target for receiving a PC5-S or PC5 RRC response message. The sensing and resource selection for transmitting the PC5-S or PC5 RRC response message(s) to UE1 may be conducted within 425-a (e.g., PC5RTT timer) or 430 (e.g., PC5Res timer) based different sensing and resource selection schemes at the receiver side (e.g., long or short sensing for resource selection, random resource selection without sensing at an Rx UE). UE1 is inactive state for sidelink communications while PC5RTT timer is running.

In some examples, the UE2 may start a timer (e.g., a PC5RRC timer based on the latency requirement or a PC5RTT timer based on communication direction switching) at the first symbol or slot 420 after receiving one or more PC5-S or PC5 RRC messages. While the timer is running (e.g., during the duration of PC5RRC timer), the UE2 may process the sidelink message from UE1 and may switch to transmitting mode at 425-a and may transmit the response message(s) at 430. In some implementations, the timer may include two portions, a PC5RTT timer for switching communication direction and a PC5Res timer for transmitting the response message(s), where the PC5Res timer is automatically activated when the PC5RTT timer expires. In some cases, the timer (e.g., the duration of PC5RRC timer or the combined duration of PC5RTT timer and PC5Res timer) may be bounded by a latency target for the PC5-S or PC5 RRC response message (e.g., a T400 timer value configured for latency bound between RRCReconfigurationSidelink and RRCReconfigurationCompleteSidelink or RRCReconfigurationFailureSidelink). The sensing and resource selection for transmitting a PC5 response message to UE1 may be conducted within 425-a or 430 based different sensing and resource selection schemes at the transmitter side (e.g., long or short sensing for resource selection, random resource selection without sensing at a Tx UE). UE2 is inactive state for sidelink communications while PC5RTT timer is running.

While the timer is running (e.g., during the duration of PC5RRC timer or PC5Res timer) for PC5-S or PC5 RRC response message(s), the UE2 may transmit, and the UE1 may monitor for and receive the response message(s). In some examples, the UE2 may terminate the timer (e.g., PC5RRC timer or PC5Res timer) at the first symbol or slot 435 after transmitting the response message(s) to end the duration for transmitting PC5-S or PC5 RRC response message(s), and the UE2 may and switch back to the Rx mode at 425-b within the ON duration 410-a. The UE1 may stop the timer (e.g., PC5RRC timer or PC5Res timer) at the first symbol or slot 435 after receiving the one or more response messages to end the duration for receiving the PC5-S or PC5 RRC response message(s), and may switch back to the Tx mode at 425-b within the ON duration 410-a. UE1 or UE2 may be in an active state for reversed direction communications (e.g., receiving or transmitting PC5-S or PC5 RRC response message(s)) on sidelink while PC5RRC timer or PC5Res timer is running.

In an example of Rx-centric sidelink DRX in FIG. 4B, the UE (e.g., UE1) may start a timer (e.g., a PC5RRC timer or a PC5RTT timer) for switching communication directions within the directional ON duration 410-c. In such examples, the transmitting UE (e.g., UE2) may transmit one or more PC5-S or PC5 RRC message to UE1 within a required latency (or reduced latency relative to a latency incurred by receiving the PC5 response messages at the next ON duration 410-d of directional DRX cycle 406-b).

The UE2 may transmit PC5-S or PC5 RRC message(s) during the directional DRX ON duration 410-c and during the Rx period 440, and UE1 may receive the PC5-S or PC5 RRC message(s) from the UE2 during the Rx period 440 within ON duration 410-c.

To meet a latency requirement of the PC5-S or PC5 RRC message between the UE1 and UE2, the UE1 may start a timer (e.g., a PC5RRC timer based on the latency requirement or a PC5RTT timer based on UE's communication direction switching) at the first symbol or slot 445 after receiving the PC5-S or PC5 RRC message from the UE2. Based on starting the timer, the UE1 may switch at 450-a from an Rx mode to a Tx mode. In some implementations, the timer may include two portions, a PC5RTT timer for switching communication directions and a PC5Res timer for monitoring the response message(s), where PC5Res timer is automatically activated when the PC5RTT timer expires. In some cases, the timer(s) (e.g., the duration of PC5RRC timer or the combined duration of PC5RTT timer and PC5Res timer) may be bounded by a latency target for the PC5-S or PC5 RRC messages. The sensing and resource selection for transmitting the response message(s) to UE2 may be conducted within 450-a (e.g., PC5RTT timer) or 455 (e.g., PC5Res timer) based different sensing and resource selection schemes at the transmitter side (e.g., long or short sensing for resource selection, random resource selection without sensing at a Tx UE). In some cases, the UE1 may be in an inactive state for sidelink communications while PC5RTT timer is running.

In some examples, the UE2 may start a timer (e.g., a PC5RRC timer or a PC5RTT timer) at the first symbol or slot 445 after transmitting the PC5-S or PC5 RRC message(s). While the timer is running (e.g., during the duration of PC5RRC timer), the UE2 may switch to a receiving mode 450-a and monitor and receive the response message(s) at 455. In some implementations, the timer may include two portions, a PC5RTT timer for switching communication directions and a PC5Res timer for transmitting the feedback or response message(s), where the PC5Res timer is automatically activated when the PC5RTT timer expires. In some cases, the timer (e.g., the duration of PC5RRC timer or the combined duration of PC5RTT timer and PC5Res timer) may be bounded by a latency target for the PC5 RRC(s) (e.g., a T400 timer value configured for latency bound between RRCReconfigurationSidelink and RRCReconfigurationCompleteSidelink or RRCReconfigurationFailureSidelink). The sensing and resource selection for transmitting a PC5 response message(s) to UE1 may be conducted within 350-a or 355 based on different sensing and resource selection schemes at the receiver side (e.g., long or short sensing for resource selection, random resource selection without sensing at an Rx UE). In some cases, the UE2 may be in an inactive state for sidelink communications while PC5RTT timer is running.

While the timer is running (e.g., during the duration of PC5RRC timer or PC5Res timer) for PC5 response message(s), the UE1 may transmit, and the UE2 may monitor for and receive the response message(s). In some examples, the UE1 may stop the timer (e.g., PC5RRC timer or PC5Res timer) at the first symbol or slot 460 after transmitting the PC5 response message to end the duration for transmitting PC5-S or PC5 RRC response message(s), and the UE1 may switch back to the Rx mode at 450-b within the ON duration 410-c. The UE2 may stop the timer (e.g., a PC5RRC timer or PC5Res timer) at the first symbol or slot 460 after receiving the sidelink response messages to end the duration of receiving the PC5-S or PC5 RRC response message(s), and may switch back to the Tx mode at 450-b within the ON duration 410-c. UE1 or UE2 is in active state for reversed direction communications (e.g., transmitting or receiving PC5-S or PC5 RRC response message(s)) on sidelink while PC5RRC timer or PC5Res timer is running.

In some cases, the timer (e.g., the duration of PC5RRC timer or the combined duration of PC5RTT timer and PC5Res timer) may be bounded by the minimum latency requirement of multiple latency requirements or by the latency requirement of the PC5-S or PC5 RRC message or logic channel carrying the PC5-S or PC5 RRC message with highest priority if multiple PC5-S or PC5 RRC responses are multiplexed into one response message transmission.

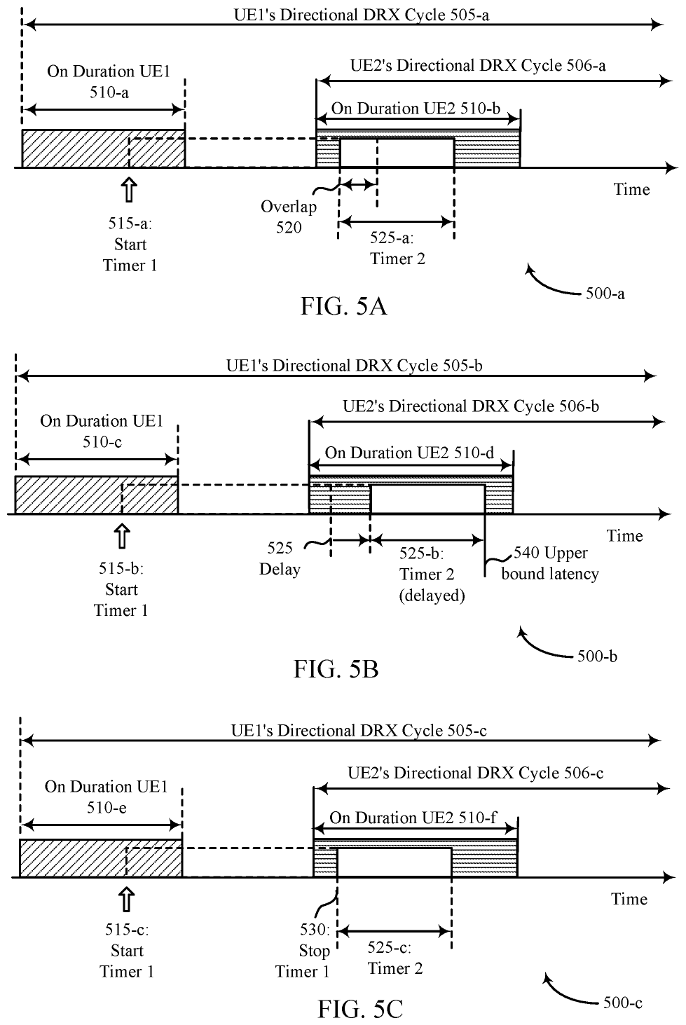

FIGS. 5A, 5B, and 5C illustrate example resource diagrams 500 that support timer operations for directional sidelink DRX in accordance with aspects of the present disclosure. In some examples, sidelink directional DRX diagram 500-a, 500-b, and 500-c may implement aspects of wireless communication system 100 and wireless communications system 200. For example, sidelink directional DRX diagrams 500-a, 500-b, and 500-c may be implemented by one or more UEs 115 in sidelink communication as described with reference to FIGS. 1 and 2. In some cases, a base station may transmit control signaling to the one or more UEs including a sidelink DRX configuration or a timer configuration for a discontinuous cycle 505 or 506 (e.g., a DRX cycle 505-a, 505-b, 505-c, 506-a, 506-b, or 506-c).

In some examples, as illustrated in FIG. 5A, during a first ON duration 510-a of the DRX cycle 505-a, a UE (e.g., UE1) may start a timer (e.g., Timer 1) at 515-a for switching between a first communications mode (e.g., a Tx or an Rx mode) to a second communications mode (e.g., an Rx or Tx mode). In some cases, the first timer may overlap at 520 with another ON duration 510-b of the DRX cycle 506-a and with at least a portion of a second timer (e.g., Timer 2 for duration 525-a).

In a first example shown in FIG. 5B, in cases that the duration of Timer 1 is determined to overlap with at least a portion of the duration of Timer 2, the timer extension for Timer 1 (e.g., PC5RRC1 or PC5Res1 for the UE's response to the other UE extended from the first directional ON duration 510-c) may delay 525 the start of Timer 2 (e.g., PC5RRC2 or PC5RRT2 within the second directional ON duration 510-d). In some cases, the UE may delay Timer 2 based on an upper bound latency 540 for Timer 2. For example, if Timer 2 overlaps with the timer extension of Timer 1 from the previous directional ON duration 510-c (e.g., PC5RRC1 or PC5Res1), the UE may delay the start of Timer 2 to avoid conflicting timer operation.

In a second example shown in FIG. 5C, in cases that the duration of Timer 1 is determined to overlap with at least a portion of the duration of Timer 2, at least one of the timers (e.g., PC5RRT1 or PC5Res1 in the directional ON duration 510-e) may be stopped at 530. For example, the UE may disable Timer 1 at 530 if the extension of Timer 1 overlaps with the next directional ON duration 510-f (e.g., another UE's directional ON duration of directional DRX cycle 506-c), to avoid conflicting timer operation.

In some examples, the UE may determine to delay or disable a timer based on priority of the sidelink information (e.g., based on the priority of a MAC-CE for feedback or report or the highest priority of MAC-CEs for feedbacks or reports, or based on the priority of a PC5-S or PC5 RRC message or the logic channel carrying the PC5-S or PC5 RRC message or the highest priority of PC5-S or PC5 RRC messages or the logic channels carrying the PC5-S or PC5 RRC messages) transmitted during the respective timer operation period. For example, a timer extension for a high priority MAC-CE may override a timer for a low priority MAC-CE, or a high priority PC5-S or PC5 RRC message or higher priority logic channel carrying the PC5-S or PC5 RRC message may override a low priority PC5-S or PC5 RRC message or a lower logic channel.

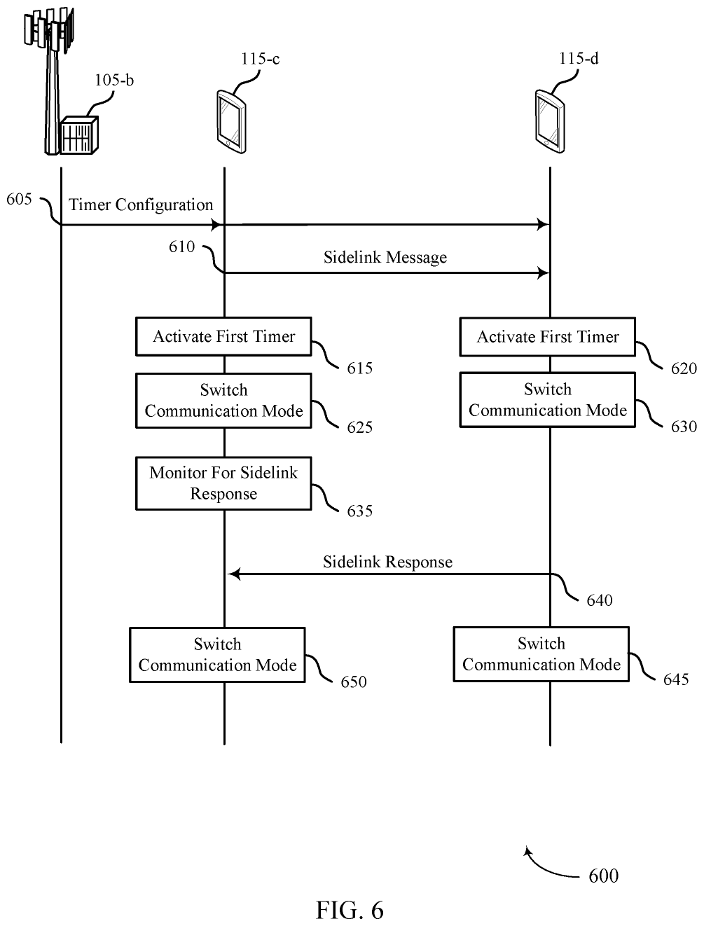

FIG. 6 illustrates an example of a process flow 600 that supports timer operations for directional sidelink DRX in accordance with aspects of the present disclosure. In some examples, process flow 600 may implement aspects of wireless communications system 100, wireless communication system 200, and sidelink DRX diagrams 3A through 5C. The process flow 600 may illustrate an example of base station 105-b which may configure UE 115-c and UE 115-d with one or more timer configurations for switching communication direction during a discontinuous cycle. Alternative examples of the following may be implemented, where some processes are performed in a different order than described or are not performed. In some cases, processes may include additional features not explicitly detailed below, or further processes may be added.

At 605, the base station 105-b may transmit, to UE 115-c and UE 115-d, a configuration for at least a first timer (e.g., a first active duration) for switching a communication direction during a first active duration of a DRX cycle (e.g., an active duration of a first DRX cycle) for sidelink communications for the UE 115-c and UE 115-d, for example, via Uu RRC configuration or via Uu MAC-CE activation or deactivation. In some examples, the base station 105-b may determine a configuration for at least the first timer based on UE capability information for sidelink or UE assistance information for sidelink received from UE 115-c or UE 115-d (e.g., communication direction switching time). In some examples, UE 115-c may send a configuration for at least the first timer via PC5 RRC message in UE 115-d is out of the base station 105-b coverage.

In some examples, when out of the network coverage, UE 115-c and UE 115-d mat receive a configuration for at least a first timer for switching a communication direction during a first active duration of a DRX cycle from a special UE 115 such as an RSU, a group lead, a cluster head, or a scheduling UE, for example, via PC5 RRC configuration or via PC5 MAC-CE activation or deactivation.

At 610, the UE 115-c (e.g., the first UE) may transmit a sidelink signal to the UE 115-d (e.g., the second UE) within the first active duration of the DRX cycle, and the UE 115-d may receive the sidelink signal within the first active duration.

At 615, the UE 115-c may activate the first timer based on transmitting the sidelink signal based on the configuration. At 620, the UE 115-d may activate a first timer based on the configuration received at 605. In some examples, the duration for the first timer may be based on a latency value associated with the sidelink signal, a sidelink response message associated with the sidelink signal, or both. In some other examples, the duration of the first timer is based on a reliability target associated with the sidelink signal or the sidelink response, a priority associated with the sidelink signal, the sidelink response, or both.

In some examples, activating the first timer may include activating a first portion of the first timer corresponding to a duration for switching from the transmission mode to the reception mode, and activating a second portion of the first timer corresponding to a duration for receiving the sidelink response to the sidelink signal during the first active duration. In some cases, the UE 115-c may activate the second portion of the first timer upon expiration of the first portion of the first timer.

In some examples, the sidelink signal transmitted from the UE 115-c may be a triggering indication, a sidelink measurement reference signal, or a sidelink message. The UE 115-c may transmit the sidelink signal during a first symbol or a first slot within the first active duration, and may activate the first timer at a second symbol following the first symbol or a second slot following the first slot. In some examples, the triggering indication includes a CSI request, an RSRP request, a CBR request, a beam management request, or any combination thereof. In some examples, the sidelink signal may be sidelink control information or a MAC-CE, and the sidelink response to the sidelink signal includes one or more MAC-CEs. In such examples, the first timer may be a MAC-CE timer. In some other examples, the sidelink signal may and the sidelink response may include one or more PC5 control messages. In such examples, the first timer may be a PC5 RRC timer or a PC5 sidelink timer.

At 625, the first UE 115-c may switch from a transmission mode to a reception mode during the first active duration based on activating the first timer. In some examples, the transmission mode may include sensing and resource selection for transmission. At 630, the second UE 115-d may switch from a reception mode to a transmission mode during the first active duration based on activating the first timer.

At 635, the UE 115-c may monitor for a sidelink response message from the UE 115-d based on switching from the transmission mode to the reception mode, and at 640, the UE 115-d may process the sidelink message and transmit a sidelink response to the UE 115-c. The UE 115-c may receive the sidelink response to the sidelink signal from the UE 115-d during the first active duration based on the activated first timer and in accordance with the timer configuration.

Based on receiving the sidelink response, the UE 115-c may deactivate the first timer and may switch from the reception mode to a transmission mode during the first active duration.

At 645, the second UE 115-d may switch from the transmission mode back to a reception mode based on transmitting the sidelink response, and at 650 the first UE 115-c may switch from the reception mode back to a transmission mode based on receiving the sidelink response.

In some examples, the UE 115-c or the UE 115-d, or both may determine that a duration associated with the first timer overlaps a duration associated with a second timer within a second active duration of a second discontinuous cycle associated with the UE 115-d. Based on the identified overlap, the UE 115-c or the UE 115-d, or both, may modify the duration of the first timer. For example, in some cases the second active duration of the second DRX cycle occurs after the first active duration, and the UE 115-c may delay activation of the second timer within the second active duration. In some other examples, if the second active duration of the second DRX cycle occurs after the first active duration, the UE may terminate the first timer at the beginning of the second timer to avoid timer overlap. In some cases, the UEs 115 may determine whether to delay or terminate the timers based on respective channel priorities associated with the first and second active durations of the DRX cycle.

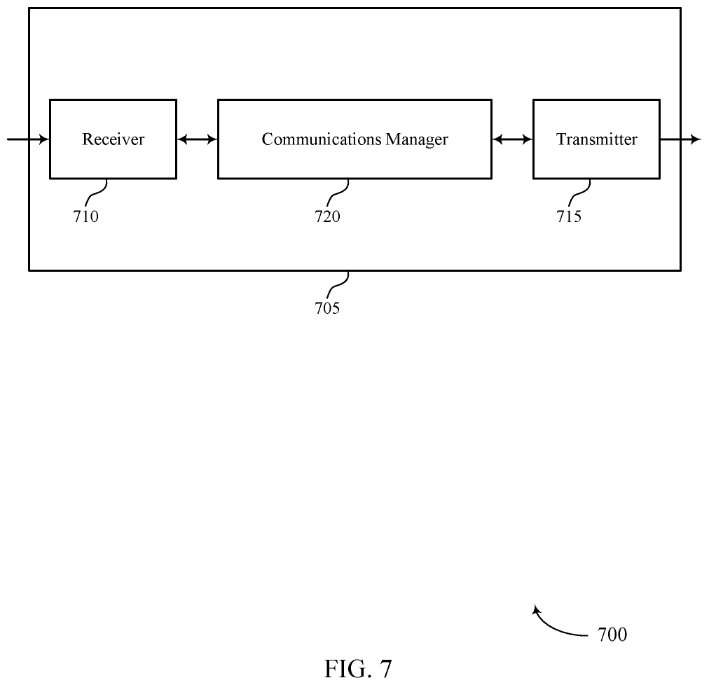

FIG. 7 shows a block diagram 700 of a device 705 that supports timer operations for directional sidelink DRX in accordance with aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to timer operations for directional sidelink DRX). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to timer operations for directional sidelink DRX). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of timer operations for directional sidelink DRX as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a first UE in accordance with examples as disclosed herein. For example, the communications manager 720 may be configured as or otherwise support a means for receiving a message indicating a configuration for at least a first active duration for the first UE, the first active duration being for a reversed communication direction during an active duration of a first discontinuous cycle for sidelink communications for the first UE. The communications manager 720 may be configured as or otherwise support a means for transmitting, within the active duration of the discontinuous cycle, a sidelink signal to a second UE. The communications manager 720 may be configured as or otherwise support a means for activating the first active duration based on transmitting the sidelink signal based on the configuration. The communications manager 720 may be configured as or otherwise support a means for switching from a transmission mode to a reception mode during the first active duration based on activating the first active duration. The communications manager 720 may be configured as or otherwise support a means for receiving, based on switching from the transmission mode to the reception mode, a sidelink response to the sidelink signal from the second UE during the first active duration based on activating the first active duration and in accordance with the configuration. The communications manager 720 may be configured as or otherwise support a means for terminating the first active duration based on receiving the sidelink response.

Additionally, or alternatively, the communications manager 720 may support wireless communications at a first UE in accordance with examples as disclosed herein. For example, the communications manager 720 may be configured as or otherwise support a means for receiving a message indicating a configuration for at least a first active duration for the first UE, the first active duration for a reversed communication direction during an active duration of a first discontinuous cycle for sidelink communications for the first UE. The communications manager 720 may be configured as or otherwise support a means for receiving, within the active duration of the first discontinuous cycle, a sidelink signal from a second UE. The communications manager 720 may be configured as or otherwise support a means for activating the first active duration based on receiving the sidelink signal based on the configuration. The communications manager 720 may be configured as or otherwise support a means for switching from a reception mode to a transmission mode during the first active duration based on activating the first active duration. The communications manager 720 may be configured as or otherwise support a means for transmitting, based on switching from the reception mode to the transmission mode, a sidelink response to the sidelink signal from the second UE during the first active duration based on activating the first active duration and in accordance with the configuration. The communications manager 720 may be configured as or otherwise support a means for terminating the first active duration based on transmitting the sidelink response.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for efficient power consumption, more efficient utilization of communication resources.

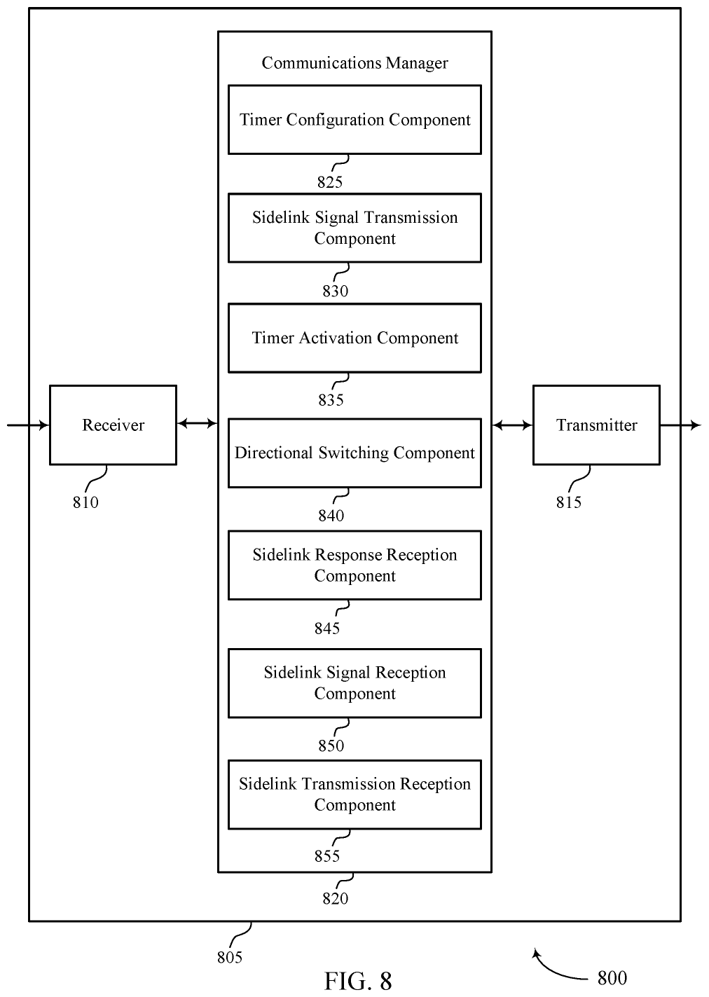

FIG. 8 shows a block diagram 800 of a device 805 that supports timer operations for directional sidelink DRX in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to timer operations for directional sidelink DRX). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to timer operations for directional sidelink DRX). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of timer operations for directional sidelink DRX as described herein. For example, the communications manager 820 may include a timer configuration component 825, a sidelink signal transmission component 830, a timer activation component 835, a directional switching component 840, a sidelink response reception component 845, a sidelink signal reception component 850, a sidelink transmission reception component 855, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a first UE in accordance with examples as disclosed herein. The timer configuration component 825 may be configured as or otherwise support a means for receiving a message indicating a configuration for at least a first active duration for the first UE, the first active duration being for a reversed communication direction during an active duration of a first discontinuous cycle for sidelink communications for the first UE. The sidelink signal transmission component 830 may be configured as or otherwise support a means for transmitting, within the active duration of the first discontinuous cycle, a sidelink signal to a second UE. The timer activation component 835 may be configured as or otherwise support a means for activating the first active duration based on transmitting the sidelink signal based on the configuration. The directional switching component 840 may be configured as or otherwise support a means for switching from a transmission mode to a reception mode during the first active duration based on activating the first active duration. The sidelink response reception component 845 may be configured as or otherwise support a means for receiving, based on switching from the transmission mode to the reception mode, a sidelink response to the sidelink signal from the second UE during the first active duration based on activating the first active duration and in accordance with the configuration. The directional switching component 840 may be configured as or otherwise support a means for terminating the first active duration based on receiving the sidelink response.

Additionally, or alternatively, the communications manager 820 may support wireless communications at a first UE in accordance with examples as disclosed herein. The timer configuration component 825 may be configured as or otherwise support a means for receiving a message indicating a configuration for at least a first active duration for the first UE, the first active duration being for switching a communication direction during an active duration of a first discontinuous cycle for sidelink communications for the first UE. The sidelink signal reception component 850 may be configured as or otherwise support a means for receiving, within the active duration of the first discontinuous cycle, a sidelink signal from a second UE. The timer activation component 835 may be configured as or otherwise support a means for activating the first active duration based on receiving the sidelink signal based on the configuration. The directional switching component 840 may be configured as or otherwise support a means for switching from a reception mode to a transmission mode during the first active duration based on activating the first active duration. The sidelink transmission reception component 855 may be configured as or otherwise support a means for transmitting, based on switching from the reception mode to the transmission mode, a sidelink response to the sidelink signal from the second UE during the first active duration based on activating the first active duration and in accordance with the configuration. The directional switching component 840 may be configured as or otherwise support a means for terminating the reception mode during the first active duration based on transmitting the sidelink response.

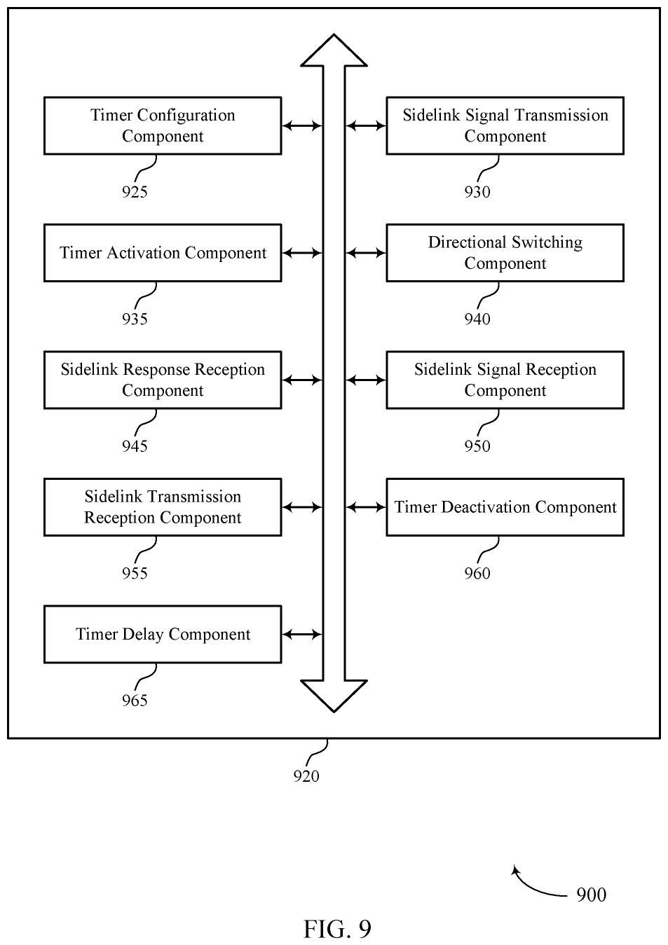

FIG. 9 shows a block diagram 900 of a communications manager 920 that supports timer operations for directional sidelink DRX in accordance with aspects of the present disclosure. The communications manager 920 may be an example of aspects of a communications manager 720, a communications manager 820, or both, as described herein. The communications manager 920, or various components thereof, may be an example of means for performing various aspects of timer operations for directional sidelink DRX as described herein. For example, the communications manager 920 may include a timer configuration component 925, a sidelink signal transmission component 930, a timer activation component 935, a directional switching component 940, a sidelink response reception component 945, a sidelink signal reception component 950, a sidelink transmission reception component 955, a timer deactivation component 960, a timer delay component 965, or any combination thereof. Each of these components may communicate, directly or indirectly, with one another (e.g., via one or more buses).

The communications manager 920 may support wireless communications at a first UE in accordance with examples as disclosed herein. The timer configuration component 925 may be configured as or otherwise support a means for receiving a message indicating a configuration for at least a first active duration for the first UE, the first active duration being for a reversed communication direction during an active duration of a first discontinuous cycle for sidelink communications for the first UE. The sidelink signal transmission component 930 may be configured as or otherwise support a means for transmitting, within the active duration of the first discontinuous cycle, a sidelink signal to a second UE. The timer activation component 935 may be configured as or otherwise support a means for activating the first active duration based on transmitting the sidelink signal based on the configuration. The directional switching component 940 may be configured as or otherwise support a means for switching from a transmission mode to a reception mode during the first active duration based on activating the first active duration. The sidelink response reception component 945 may be configured as or otherwise support a means for receiving, based on switching from the transmission mode to the reception mode, a sidelink response to the sidelink signal from the second UE during the first active duration based on activating the first active duration and in accordance with the configuration. In some examples, the directional switching component 940 may be configured as or otherwise support a means for terminating the first active duration based on receiving the sidelink response.

In some examples, the sidelink signal includes a triggering indication, and the sidelink signal transmission component 930 may be configured as or otherwise support a means for transmitting the sidelink signal during a first symbol or a first slot within the active duration of the first discontinuous cycle. In some examples, the sidelink signal includes a triggering indication, and the timer activation component 935 may be configured as or otherwise support a means for activating the first active duration at a second symbol following the first symbol or a second slot following the first slot based on the transmitting.

In some examples, the triggering indication includes a channel state information request, a reference signal received power request, a channel busy ratio request, a beam request, or any combination thereof.

In some examples, the directional switching component 940 may be configured as or otherwise support a means for switching from the reception mode to the transmission mode during the first active duration, where the transmission mode includes sensing and resource selection for the sidelink signal.

In some examples, a duration for the first active duration is based on a latency value associated with the sidelink signal, the sidelink response, or both.

In some examples, the first active duration is based on a reliability target associated with the sidelink signal or the sidelink response, a priority associated with the sidelink signal, the sidelink response, or both.

In some examples, to support activating the first active duration, the timer activation component 935 may be configured as or otherwise support a means for activating a first portion of the first active duration, the first portion including a duration for switching from the transmission mode to the reception mode. In some examples, to support activating the first active duration, the timer activation component 935 may be configured as or otherwise support a means for activating a second portion of the first active duration, the second portion including a duration for receiving the sidelink response to the sidelink signal during the first active duration.

In some examples, the second portion of the first active duration is activated upon expiration of the first portion of the first active duration.

In some examples, the timer deactivation component 960 may be configured as or otherwise support a means for deactivating the first active duration and switching from the reception mode to the transmission mode during the first active duration and based on receiving the sidelink response.

In some examples, the sidelink signal includes sidelink control information (SCI) or a medium access control (MAC) control element (MAC-CE) and the sidelink response includes one or more MAC-CEs.

In some examples, activating the first active duration includes activating a medium access control (MAC) control element (MAC-CE) timer.

In some examples, the sidelink signal and the sidelink response include one or more PC5 control messages and activating the first active duration includes activating a PC5 RRC timer (PCSRRC) or a sidelink timer. In some examples, terminating the first active duration includes terminating a medium access control (MAC) control element (MAC-CE) timer, a PC5 radio resource control (PCSRRC) timer, or a sidelink timer

In some examples, the timer configuration component 925 may be configured as or otherwise support a means for determining that the first active duration overlaps with a second active duration within an active duration of a second discontinuous cycle associated with the second UE. In some examples, the timer configuration component 925 may be configured as or otherwise support a means for modifying the first active duration based on the determining.

In some examples, the timer delay component 965 may be configured as or otherwise support a means for delaying activation of the second active duration within the active duration of the second discontinuous cycle based on the determining.

In some examples, the timer deactivation component 960 may be configured as or otherwise support a means for terminating the first active duration at a beginning of the second active duration based on the determining.

In some examples, the timer configuration component 925 may be configured as or otherwise support a means for modifying the duration of the first active duration based on respective communication (e.g., channel) priorities associated with the first active duration and the second active duration.

Additionally, or alternatively, the communications manager 920 may support wireless communications at a first UE in accordance with examples as disclosed herein. In some examples, the timer configuration component 925 may be configured as or otherwise support a means for receiving a message indicating a configuration for a first active duration for the first UE, the first active duration being for a reversed communication direction during an active duration of a first discontinuous cycle for sidelink communications for the first UE. The sidelink signal reception component 950 may be configured as or otherwise support a means for receiving, within the active duration of the first discontinuous cycle, a sidelink signal from a second UE. In some examples, the timer activation component 935 may be configured as or otherwise support a means for activating the first active duration based on receiving the sidelink signal based on the configuration. In some examples, the directional switching component 940 may be configured as or otherwise support a means for switching from a reception mode to a transmission mode during the first active duration based on activating the first active duration. The sidelink transmission reception component 955 may be configured as or otherwise support a means for transmitting, based on switching from the reception mode to the transmission mode, a sidelink response to the sidelink signal from the second UE during the first active duration based on activating the first active duration and in accordance with the configuration. In some examples, the directional switching component 940 may be configured as or otherwise support a means for terminating the first active duration based on transmitting the sidelink response.

In some examples, the sidelink signal includes a triggering indication or a sidelink measurement reference signal, and the sidelink signal reception component 950 may be configured as or otherwise support a means for receiving the sidelink signal during a first symbol or a first slot within the active duration of the first discontinuous cycle. In some examples, the sidelink signal includes a triggering indication or a sidelink measurement reference signal, and the timer activation component 935 may be configured as or otherwise support a means for activating the first active duration at a second symbol following the first symbol or a second slot following the first slot based on the receiving.

In some examples, the triggering indication includes a channel state information request, a reference signal received power request, a channel busy ratio request, a beam request, or any combination thereof.

In some examples, the sidelink signal reception component 950 may be configured as or otherwise support a means for processing the sidelink signal within the first active duration. In some examples, the directional switching component 940 may be configured as or otherwise support a means for switching from the reception mode to the transmission mode during the first active duration, where the transmission mode includes sensing and resource selection for the sidelink signal.

In some examples, the first active duration is based on a latency value associated with the sidelink signal, the sidelink response, or both.

In some examples, the first active duration is based on a reliability target associated with the sidelink signal or the sidelink response, a priority associated with the sidelink signal or the sidelink response, or both.

In some examples, to support activating the first active duration, the timer activation component 935 may be configured as or otherwise support a means for activating a first portion of the first active duration, the first portion including a duration for switching from the reception mode to the transmission mode. In some examples, to support activating the first active duration, the timer activation component 935 may be configured as or otherwise support a means for activating a second portion of the first active duration, the second portion including a duration for transmitting the sidelink response to the sidelink signal during the first active duration.

In some examples, the second portion of the first active duration is activated upon expiration of the first portion of the first active duration.

In some examples, the timer deactivation component 960 may be configured as or otherwise support a means for deactivating the first active duration and switching from the transmission mode to the reception mode during the first active duration and based on transmitting the sidelink response.

In some examples, the sidelink signal includes sidelink control information (SCI) or a medium access control (MAC) control element (MAC-CE) and the sidelink response includes one or more MAC-CEs.

In some examples, activating the first active duration includes activating a medium access control (MAC) control elements (MAC-CE) timer, a PC5 radio resource control (PCSRRC) timer, or a sidelink timer.

In some examples, terminating the first active duration includes terminating a medium access control (MAC) control element (MAC-CE) timer, a PC5 radio resource control (PCSRRC) timer, or a sidelink timer.

In some examples, the timer configuration component 925 may be configured as or otherwise support a means for determining that the first active duration overlaps with a second active duration within am active duration of a second discontinuous cycle associated with the second UE. In some examples, the timer configuration component 925 may be configured as or otherwise support a means for modifying the first active duration based on the determining.

In some examples, the timer delay component 965 may be configured as or otherwise support a means for delaying activation of the second active duration within the active duration of the second discontinuous cycle based on the determining.

In some examples, the timer deactivation component 960 may be configured as or otherwise support a means for terminating the first active duration at the beginning of the second active duration based on the determining.

In some examples, the timer configuration component 925 may be configured as or otherwise support a means for modifying first active duration based on respective communication (e.g., channel) priorities associated with the first active duration and the second active duration.

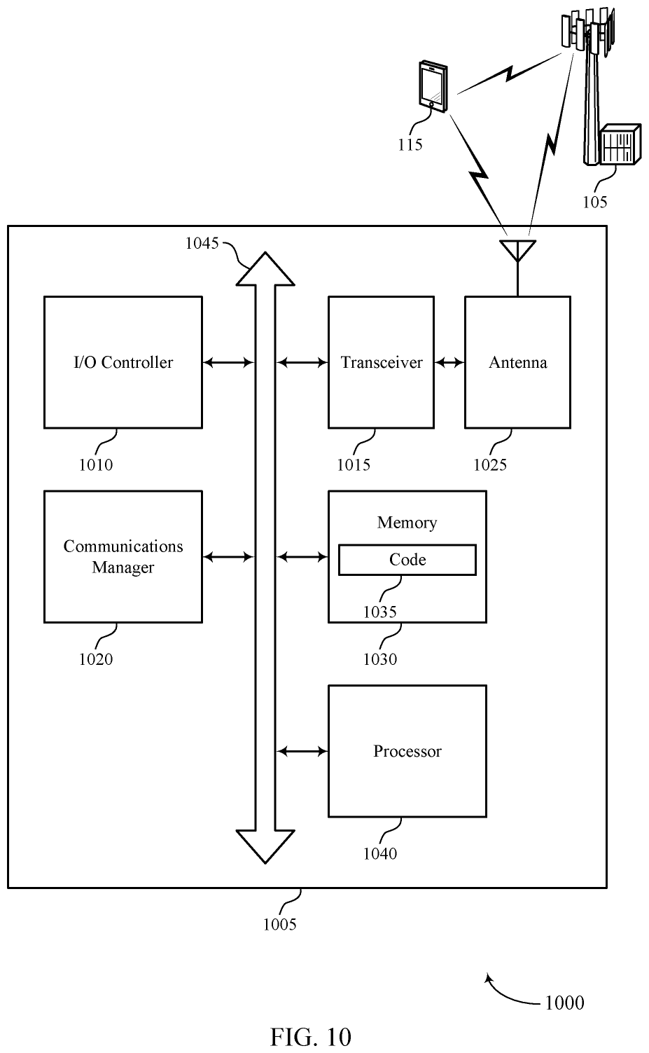

FIG. 10 shows a diagram of a system 1000 including a device 1005 that supports timer operations for directional sidelink DRX in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting timer operations for directional sidelink DRX). For example, the device 1005 or a component of the device 1005 may include a processor 1040 and memory 1030 coupled to the processor 1040, the processor 1040 and memory 1030 configured to perform various functions described herein.

The communications manager 1020 may support wireless communications at a first UE in accordance with examples as disclosed herein. For example, the communications manager 1020 may be configured as or otherwise support a means for receiving a message indicating a configuration for a first active duration for the first UE, the first active duration being for a reversed communication direction during an active duration of a first discontinuous cycle for sidelink communications for the first UE. The communications manager 1020 may be configured as or otherwise support a means for transmitting, within the active duration of the first discontinuous cycle, a sidelink signal to a second UE. The communications manager 1020 may be configured as or otherwise support a means for activating the first active duration based on transmitting the sidelink signal based on the configuration. The communications manager 1020 may be configured as or otherwise support a means for switching from a transmission mode to a reception mode during the first active duration based on activating the first active duration. The communications manager 1020 may be configured as or otherwise support a means for receiving, based on switching from the transmission mode to the reception mode, a sidelink response to the sidelink signal from the second UE during the first active duration based on activating the first active duration and in accordance with the configuration. The communications manager 1020 may be configured as or otherwise support a means for terminating the first active duration based on receiving the sidelink response.

Additionally, or alternatively, the communications manager 1020 may support wireless communications at a first UE in accordance with examples as disclosed herein. For example, the communications manager 1020 may be configured as or otherwise support a means for receiving a message indicating a configuration for a first active duration for the first UE, the first active duration being for a reversed communication direction during an active duration of a first discontinuous cycle for sidelink communications for the first UE. The communications manager 1020 may be configured as or otherwise support a means for receiving, within the active duration of the first discontinuous cycle, a sidelink signal from a second UE. The communications manager 1020 may be configured as or otherwise support a means for activating the first active duration based on receiving the sidelink signal based on the configuration. The communications manager 1020 may be configured as or otherwise support a means for switching from a reception mode to a transmission mode during the first active duration based on activating the first active duration. The communications manager 1020 may be configured as or otherwise support a means for transmitting, based on switching from the reception mode to the transmission mode, a sidelink response to the sidelink signal from the second UE during the first active duration based on activating the first active duration and in accordance with the configuration. The communications manager 1020 may be configured as or otherwise support a means for terminating the first active duration based on transmitting the sidelink response.

By including or configuring the communications manager 1020 in accordance with examples as described herein, the device 1005 may support techniques for improved communication reliability, reduced latency, improved user experience related to reduced latency, efficient power consumption, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of timer operations for directional sidelink DRX as described herein, or the processor 1040 and the memory 1030 may be otherwise configured to perform or support such operations.

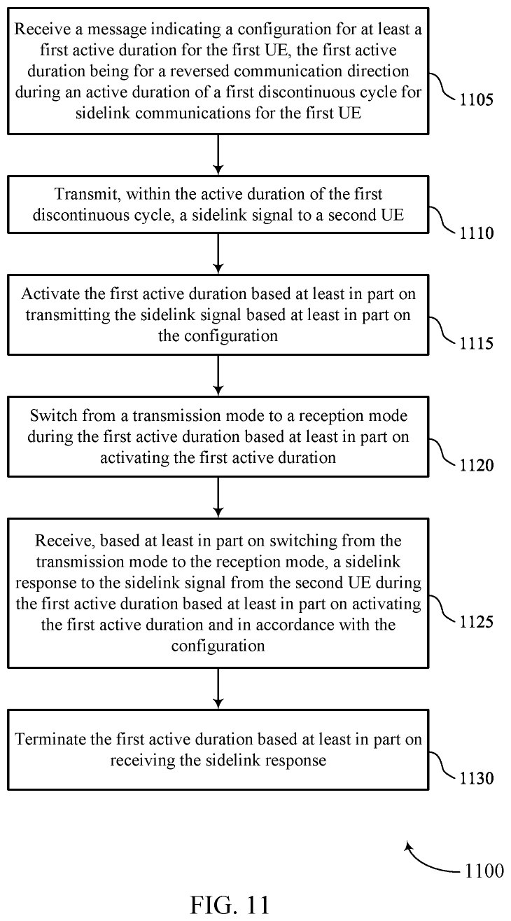

FIG. 11 shows a flowchart illustrating a method 1100 that supports timer operations for directional sidelink DRX in accordance with aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving a message indicating a configuration for at least a first active duration for the first UE, the first active duration being for a reversed communication direction during an active duration of a first discontinuous cycle for sidelink communications for the first UE. The operations of 1105 may be performed in accordance with examples as disclosed herein. In some examples, aspects of the operations of 1105 may be performed by a timer configuration component 925 as described with reference to FIG. 9.

At 1110, the method may include transmitting, within the active duration of the first discontinuous cycle, a sidelink signal to a second UE. The operations of 1110 may be performed in accordance with examples as disclosed herein. In some examples, aspects of the operations of 1110 may be performed by a sidelink signal transmission component 930 as described with reference to FIG. 9.

At 1115, the method may include activating the first active duration based on transmitting the sidelink signal based on the configuration. The operations of 1115 may be performed in accordance with examples as disclosed herein. In some examples, aspects of the operations of 1115 may be performed by a timer activation component 935 as described with reference to FIG. 9.

At 1120, the method may include switching from a transmission mode to a reception mode during the first active duration based on activating the first active duration. The operations of 1120 may be performed in accordance with examples as disclosed herein. In some examples, aspects of the operations of 1120 may be performed by a directional switching component 940 as described with reference to FIG. 9.

At 1125, the method may include receiving, based on switching from the transmission mode to the reception mode, a sidelink response to the sidelink signal from the second UE during the first active duration based on activating the first active duration and in accordance with the configuration. The operations of 1125 may be performed in accordance with examples as disclosed herein. In some examples, aspects of the operations of 1125 may be performed by a sidelink response reception component 945 as described with reference to FIG. 9.

At 1130, the method may include terminating the first active duration based on receiving the sidelink response. The operations of 1130 may be performed in accordance with examples as disclosed herein. In some examples, aspects of the operations of 1130 may be performed by a directional switching component 940 as described with reference to FIG. 9.

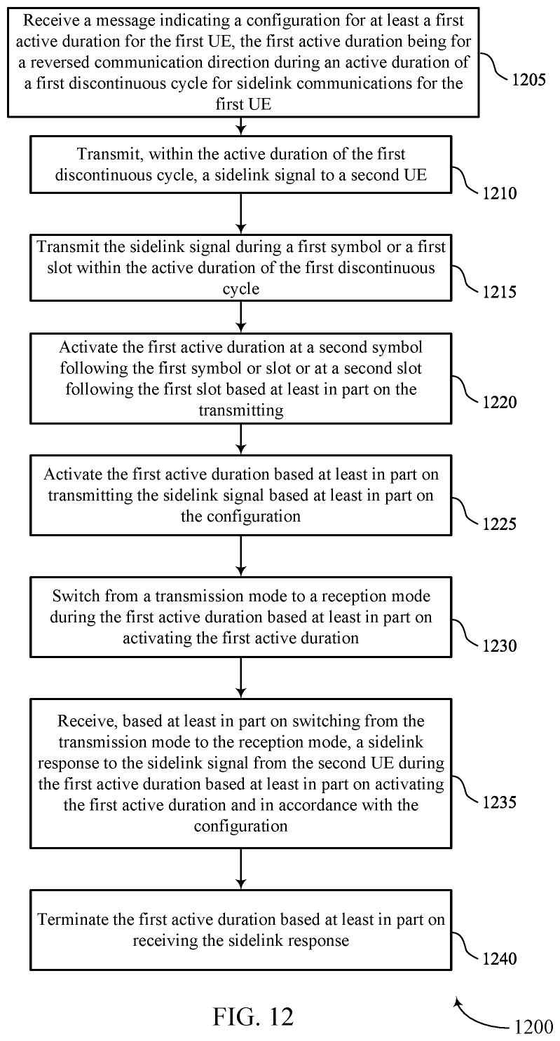

FIG. 12 shows a flowchart illustrating a method 1200 that supports timer operations for directional sidelink DRX in accordance with aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving a message indicating a configuration for at least a first active duration for the first UE, the first active duration being for a reversed communication direction during an active duration of a first discontinuous cycle for sidelink communications for the first UE. The operations of 1205 may be performed in accordance with examples as disclosed herein. In some examples, aspects of the operations of 1205 may be performed by a timer configuration component 925 as described with reference to FIG. 9.

At 1210, the method may include transmitting, within the active duration of the first discontinuous cycle, a sidelink signal to a second UE. The operations of 1210 may be performed in accordance with examples as disclosed herein. In some examples, aspects of the operations of 1210 may be performed by a sidelink signal transmission component 930 as described with reference to FIG. 9.

At 1215, the method may include transmitting the sidelink signal during a first symbol or a first slot within the active duration of the first discontinuous cycle. The operations of 1215 may be performed in accordance with examples as disclosed herein. In some examples, aspects of the operations of 1215 may be performed by a sidelink signal transmission component 930 as described with reference to FIG. 9.

At 1220, the method may include activating the first active duration at a second symbol following the first symbol or a second slot following the first slot based on the transmitting. The operations of 1220 may be performed in accordance with examples as disclosed herein. In some examples, aspects of the operations of 1220 may be performed by a timer activation component 935 as described with reference to FIG. 9.

At 1225, the method may include activating the first active duration based on transmitting the sidelink signal based on the configuration. The operations of 1225 may be performed in accordance with examples as disclosed herein. In some examples, aspects of the operations of 1225 may be performed by a timer activation component 935 as described with reference to FIG. 9.

At 1230, the method may include switching from a transmission mode to a reception mode during the first active duration based on activating the first active duration. The operations of 1230 may be performed in accordance with examples as disclosed herein. In some examples, aspects of the operations of 1230 may be performed by a directional switching component 940 as described with reference to FIG. 9.

At 1235, the method may include receiving, based on switching from the transmission mode to the reception mode, a sidelink response to the sidelink signal from the second UE during the first active duration based on activating the first active duration and in accordance with the configuration. The operations of 1235 may be performed in accordance with examples as disclosed herein. In some examples, aspects of the operations of 1235 may be performed by a sidelink response reception component 945 as described with reference to FIG. 9.

At 1240, the method may include terminating the first active duration based on receiving the sidelink response. The operations of 1240 may be performed in accordance with examples as disclosed herein. In some examples, aspects of the operations of 1240 may be performed by a directional switching component 940 as described with reference to FIG. 9.

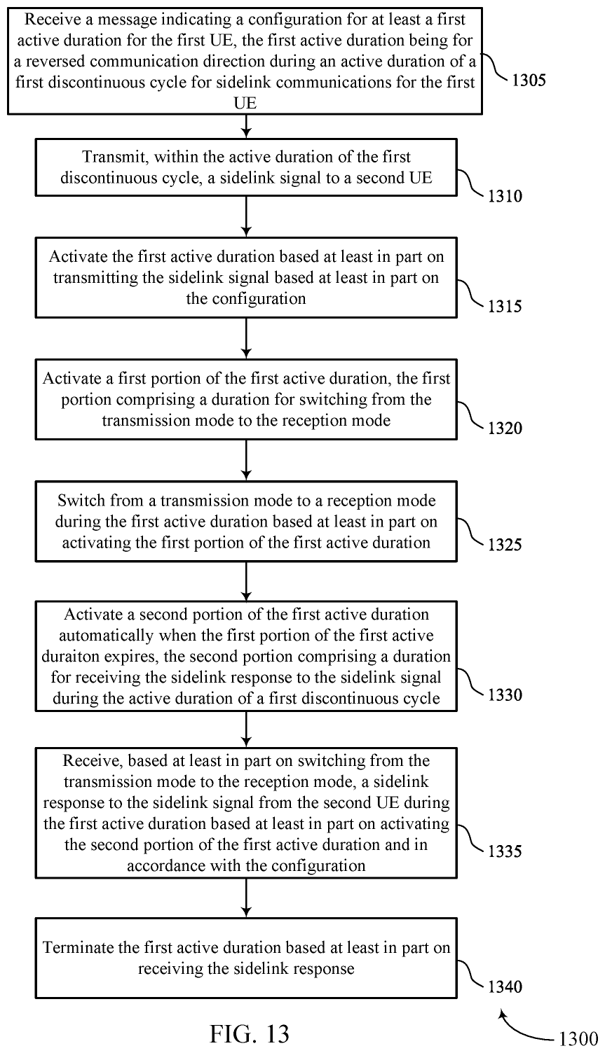

FIG. 13 shows a flowchart illustrating a method 1300 that supports timer operations for directional sidelink DRX in accordance with aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving a message indicating a configuration for at least a first active duration for the first UE, the first active duration being for a reversed communication direction during an active duration of a first discontinuous cycle for sidelink communications for the first UE. The operations of 1305 may be performed in accordance with examples as disclosed herein. In some examples, aspects of the operations of 1305 may be performed by a timer configuration component 925 as described with reference to FIG. 9.

At 1310, the method may include transmitting, within the active duration of the first discontinuous cycle, a sidelink signal to a second UE. The operations of 1310 may be performed in accordance with examples as disclosed herein. In some examples, aspects of the operations of 1310 may be performed by a sidelink signal transmission component 930 as described with reference to FIG. 9.

At 1315, the method may include activating the first active duration based on transmitting the sidelink signal based on the configuration. The operations of 1315 may be performed in accordance with examples as disclosed herein. In some examples, aspects of the operations of 1315 may be performed by a timer activation component 935 as described with reference to FIG. 9.

At 1320, the method may include activating a first portion of the first active duration, the first portion including a duration for switching from the transmission mode to the reception mode. The operations of 1320 may be performed in accordance with examples as disclosed herein. In some examples, aspects of the operations of 1320 may be performed by a timer activation component 935 as described with reference to FIG. 9.

At 1325, the method may include switching from a transmission mode to a reception mode during the first active duration based on activating the first portion of the first active duration. The operations of 1325 may be performed in accordance with examples as disclosed herein. In some examples, aspects of the operations of 1325 may be performed by a directional switching component 940 as described with reference to FIG. 9.

At 1330, the method may include activating a second portion of the first active duration, the second portion including a duration for receiving the sidelink response to the sidelink signal during the active duration of the first discontinuous cycle. The operations of 1330 may be performed in accordance with examples as disclosed herein. In some examples, aspects of the operations of 1330 may be performed by a timer activation component 935 as described with reference to FIG. 9.

At 1335, the method may include receiving, based on switching from the transmission mode to the reception mode, a sidelink response to the sidelink signal from the second UE during the first active duration based on activating the second portion of the first active duration and in accordance with the configuration. The operations of 1335 may be performed in accordance with examples as disclosed herein. In some examples, aspects of the operations of 1335 may be performed by a sidelink response reception component 945 as described with reference to FIG. 9.

At 1340, the method may include terminating the first active duration based on receiving the sidelink response. The operations of 1340 may be performed in accordance with examples as disclosed herein. In some examples, aspects of the operations of 1340 may be performed by a directional switching component 940 as described with reference to FIG. 9.

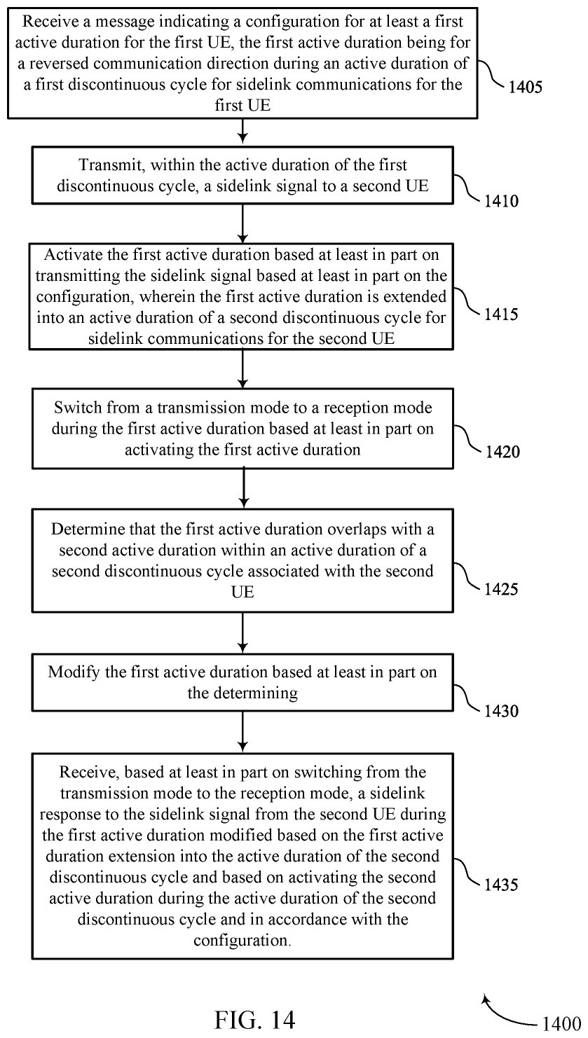

FIG. 14 shows a flowchart illustrating a method 1400 that supports timer operations for directional sidelink DRX in accordance with aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1405, the method may include receiving a message indicating a configuration for at least a first active duration for the first UE, the first active duration being for a reversed communication direction during an active duration of a first discontinuous cycle for sidelink communications for the first UE. The operations of 1405 may be performed in accordance with examples as disclosed herein. In some examples, aspects of the operations of 1405 may be performed by a timer configuration component 925 as described with reference to FIG. 9.

At 1410, the method may include transmitting, within the active duration of the first discontinuous cycle, a sidelink signal to a second UE. The operations of 1410 may be performed in accordance with examples as disclosed herein. In some examples, aspects of the operations of 1410 may be performed by a sidelink signal transmission component 930 as described with reference to FIG. 9.

At 1415, the method may include activating the first active duration based on transmitting the sidelink signal based on the configuration, where the first active duration or the second portion of the first active duration is extended into an active duration of a second discontinuous cycle for sidelink communications for the second UE. The operations of 1415 may be performed in accordance with examples as disclosed herein. In some examples, aspects of the operations of 1415 may be performed by a timer activation component 935 as described with reference to FIG. 9.

At 1420, the method may include switching from a transmission mode to a reception mode during the first active duration based on activating the first active duration. The operations of 1420 may be performed in accordance with examples as disclosed herein. In some examples, aspects of the operations of 1420 may be performed by a directional switching component 940 as described with reference to FIG. 9.

At 1425, the method may include determining that the first active duration overlaps a second active duration within an active duration of a second discontinuous cycle associated with the second UE. The operations of 1425 may be performed in accordance with examples as disclosed herein. In some examples, aspects of the operations of 1425 may be performed by a timer configuration component 925 as described with reference to FIG. 9.

At 1430, the method may include modifying the first active duration based on the determining. The operations of 1430 may be performed in accordance with examples as disclosed herein. In some examples, aspects of the operations of 1430 may be performed by a timer configuration component 925 as described with reference to FIG. 9.

At 1435, the method may include receiving, based on switching from the transmission mode to the reception mode, a sidelink response to the sidelink signal from the second UE during the first active duration modified based on the first active duration extension into the active duration of the second discontinuous cycle and based on activating the second active duration during the active duration of the second discontinuous cycle and in accordance with the configuration. The operations of 1435 may be performed in accordance with examples as disclosed herein. In some examples, aspects of the operations of 1435 may be performed by a sidelink response reception component 945 as described with reference to FIG. 9.

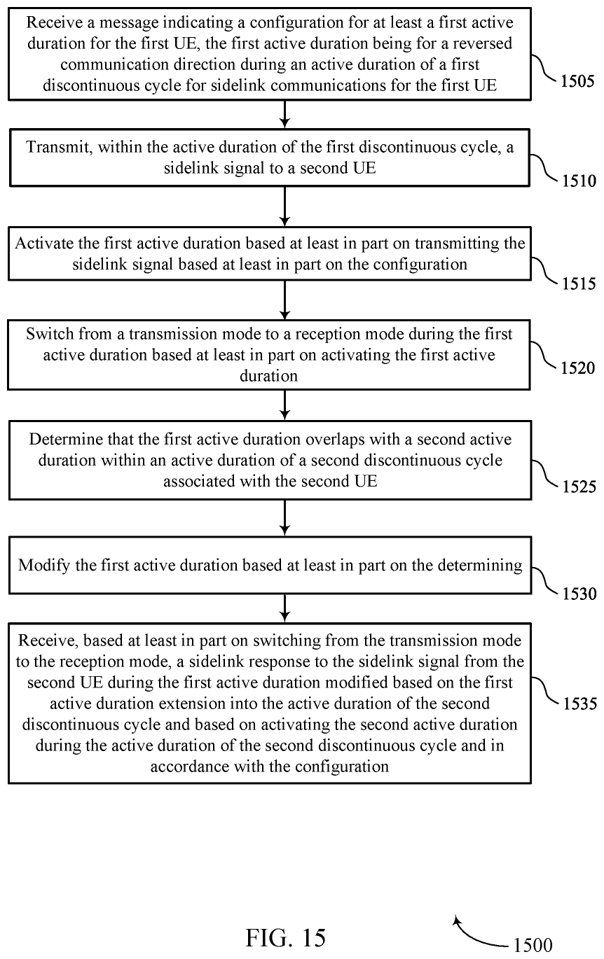

FIG. 15 shows a flowchart illustrating a method 1500 that supports timer operations for directional sidelink DRX in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a message indicating a configuration for at least a first active duration for the first UE, the first active duration being for a reversed communication direction during an active duration of a first discontinuous cycle for sidelink communications for the first UE. The operations of 1505 may be performed in accordance with examples as disclosed herein. In some examples, aspects of the operations of 1505 may be performed by a timer configuration component 925 as described with reference to FIG. 9.

At 1510, the method may include transmitting, within the active duration of the discontinuous cycle, a sidelink signal to a second UE. The operations of 1510 may be performed in accordance with examples as disclosed herein. In some examples, aspects of the operations of 1510 may be performed by a sidelink signal transmission component 930 as described with reference to FIG. 9.

At 1515, the method may include activating the first active duration based on transmitting the sidelink signal based on the configuration, where the first active duration or the second portion of the first active duration is extended into an active duration of a second discontinuous cycle for sidelink communications for the second UE. The operations of 1515 may be performed in accordance with examples as disclosed herein. In some examples, aspects of the operations of 1515 may be performed by a timer activation component 935 as described with reference to FIG. 9.

At 1520, the method may include switching from a transmission mode to a reception mode during the first active duration based on activating the first active duration. The operations of 1520 may be performed in accordance with examples as disclosed herein. In some examples, aspects of the operations of 1520 may be performed by a directional switching component 940 as described with reference to FIG. 9.

At 1525, the method may include determining that a first active duration overlaps a second active duration within an active duration of a second discontinuous cycle associated with the second UE. The operations of 1525 may be performed in accordance with examples as disclosed herein. In some examples, aspects of the operations of 1525 may be performed by a timer configuration component 925 as described with reference to FIG. 9.

At 1530, the method may include modifying the first active duration based on the determining. At 1530, the method may include modifying the first active duration based on respective priorities associated with a first sidelink response for the first active duration and a second sidelink response for the second active duration. The operations of 1530 may be performed in accordance with examples as disclosed herein. In some examples, aspects of the operations of 1530 may be performed by a timer configuration component 925 as described with reference to FIG. 9.

At 1535, the method may include receiving, based on switching from the transmission mode to the reception mode, a sidelink response to the sidelink signal from the second UE during the first active duration modified based on the first active duration extension into the active duration of the second discontinuous cycle and based on activating the second active duration during the active duration of the second discontinuous cycle and in accordance with the configuration. The operations of 1535 may be performed in accordance with examples as disclosed herein. In some examples, aspects of the operations of 1535 may be performed by a sidelink response reception component 945 as described with reference to FIG. 9.

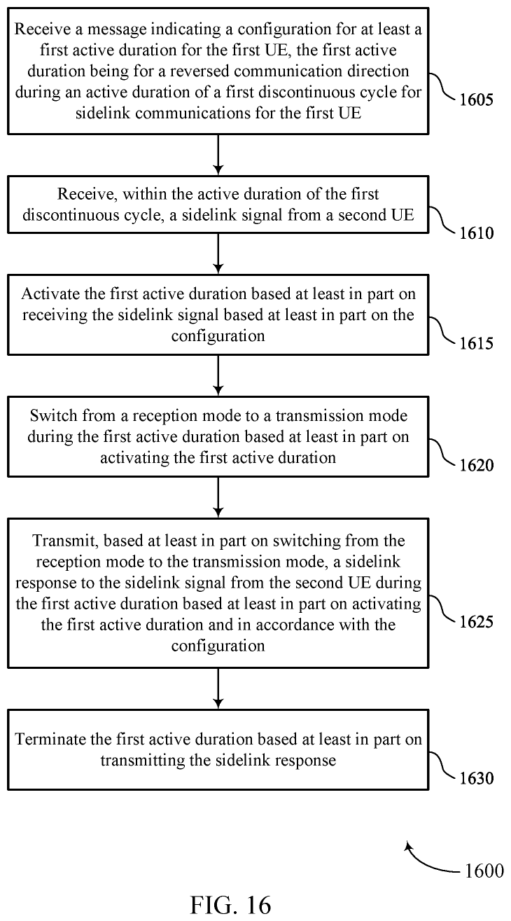

FIG. 16 shows a flowchart illustrating a method 1600 that supports timer operations for directional sidelink DRX in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a message indicating a configuration for at least a first active duration for the first UE, the first active duration being for a reversed communication direction during an active duration of a first discontinuous cycle for sidelink communications for the first UE. The operations of 1605 may be performed in accordance with examples as disclosed herein. In some examples, aspects of the operations of 1605 may be performed by a timer configuration component 925 as described with reference to FIG. 9.

At 1610, the method may include receiving, within the active duration of the first discontinuous cycle, a sidelink signal from a second UE. The operations of 1610 may be performed in accordance with examples as disclosed herein. In some examples, aspects of the operations of 1610 may be performed by a sidelink signal reception component 950 as described with reference to FIG. 9.

At 1615, the method may include activating the first active duration based on receiving the sidelink signal based on the configuration. The operations of 1615 may be performed in accordance with examples as disclosed herein. In some examples, aspects of the operations of 1615 may be performed by a timer activation component 935 as described with reference to FIG. 9.

At 1620, the method may include switching from a reception mode to a transmission mode during the first active duration based on activating the first active duration. The operations of 1620 may be performed in accordance with examples as disclosed herein. In some examples, aspects of the operations of 1620 may be performed by a directional switching component 940 as described with reference to FIG. 9.

At 1625, the method may include transmitting, based on switching from the reception mode to the transmission mode, a sidelink response to the sidelink signal from the second UE during the first active duration based on activating the first active duration and in accordance with the configuration. The operations of 1625 may be performed in accordance with examples as disclosed herein. In some examples, aspects of the operations of 1625 may be performed by a sidelink transmission reception component 955 as described with reference to FIG. 9.

At 1630, the method may include terminating the first active duration based on transmitting the sidelink response. The operations of 1630 may be performed in accordance with examples as disclosed herein. In some examples, aspects of the operations of 1630 may be performed by a directional switching component 940 as described with reference to FIG. 9.

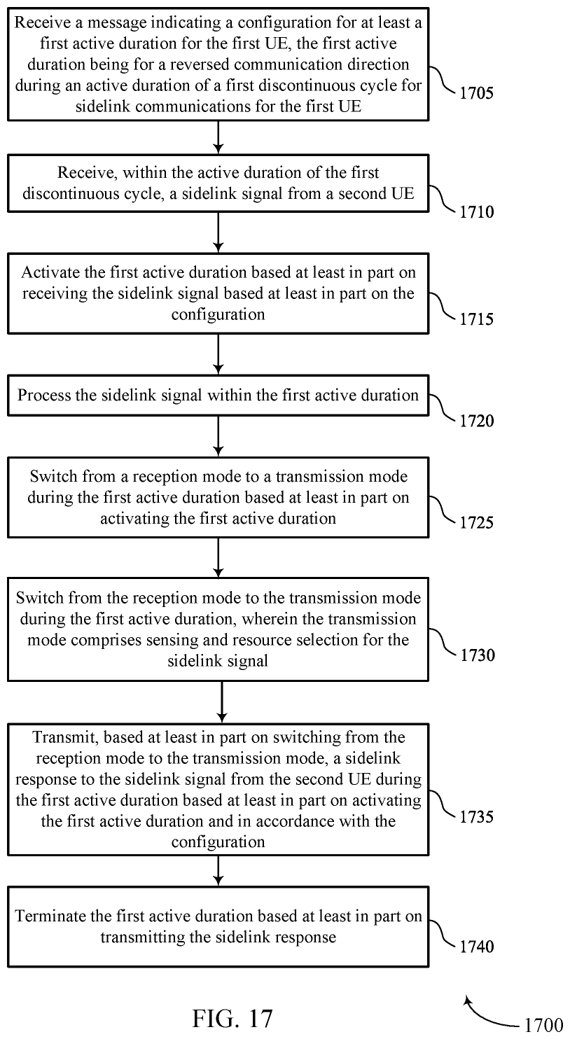

FIG. 17 shows a flowchart illustrating a method 1700 that supports timer operations for directional sidelink DRX in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving a message indicating a configuration for at least a first active duration for the first UE, the first active duration being for a reversed communication direction during an active duration of a first discontinuous cycle for sidelink communications for the first UE. The operations of 1705 may be performed in accordance with examples as disclosed herein. In some examples, aspects of the operations of 1705 may be performed by a timer configuration component 925 as described with reference to FIG. 9.

At 1710, the method may include receiving, within the active duration of the first discontinuous cycle, a sidelink signal from a second UE. The operations of 1710 may be performed in accordance with examples as disclosed herein. In some examples, aspects of the operations of 1710 may be performed by a sidelink signal reception component 950 as described with reference to FIG. 9.

At 1715, the method may include activating the first active duration based on receiving the sidelink signal based on the configuration. The operations of 1715 may be performed in accordance with examples as disclosed herein. In some examples, aspects of the operations of 1715 may be performed by a timer activation component 935 as described with reference to FIG. 9.

At 1720, the method may include processing the sidelink signal within the first active duration. The operations of 1720 may be performed in accordance with examples as disclosed herein. In some examples, aspects of the operations of 1720 may be performed by a sidelink signal reception component 950 as described with reference to FIG. 9.

At 1725, the method may include switching from a reception mode to a transmission mode during the first active duration based on activating the first active duration. The operations of 1725 may be performed in accordance with examples as disclosed herein. In some examples, aspects of the operations of 1725 may be performed by a directional switching component 940 as described with reference to FIG. 9.

At 1730, the method may include switching from the reception mode to the transmission mode during the first active duration, where the transmission mode includes sensing and resource selection for the sidelink signal. The operations of 1730 may be performed in accordance with examples as disclosed herein. In some examples, aspects of the operations of 1730 may be performed by a directional switching component 940 as described with reference to FIG. 9.

At 1735, the method may include transmitting, based on switching from the reception mode to the transmission mode, a sidelink response to the sidelink signal from the second UE during the first active duration based on activating the first active duration and in accordance with the configuration. The operations of 1735 may be performed in accordance with examples as disclosed herein. In some examples, aspects of the operations of 1735 may be performed by a sidelink transmission reception component 955 as described with reference to FIG. 9.

At 1740, the method may include terminating the first active duration based on transmitting the sidelink response. The operations of 1740 may be performed in accordance with examples as disclosed herein. In some examples, aspects of the operations of 1740 may be performed by a directional switching component 940 as described with reference to FIG. 9.

The following provides an overview of aspects of the present disclosure:

Aspect 1: A method for wireless communications at a first UE, comprising: receiving a message indicating a configuration for a first active duration for the first UE, the first active duration being for a reversed communication direction during an active duration of a first discontinuous cycle for sidelink communications for the first UE; transmitting, within the active duration of the first discontinuous cycle, a sidelink signal to a second UE; activating the first active duration based at least in part on transmitting the sidelink signal based at least in part on the configuration; switching from a transmission mode to a reception mode during the first active duration based at least in part on activating the first active duration; receiving, based at least in part on switching from the transmission mode to the reception mode, a sidelink response to the sidelink signal from the second UE during the first active duration based at least in part on activating the first active duration and in accordance with the configuration; and terminating the first active duration based at least in part on receiving the sidelink response.

Aspect 2: The method of aspect 1, wherein the sidelink signal comprises a triggering indication, a sidelink measurement reference signal, or a sidelink message, the method further comprising: transmitting the sidelink signal during a first symbol or a first slot within the active duration of the first discontinuous cycle; and activating the first active duration at a second symbol following the first symbol or slot or at a second slot following the first slot based at least in part on the transmitting.

Aspect 3: The method of aspect 2, wherein the triggering indication comprises a channel state information request, a reference signal received power request, a channel busy ratio request, a beam request, or any combination thereof.

Aspect 4: The method of any of aspects 1 through 3, further comprising: switching from the reception mode to the transmission mode after the first active duration.

Aspect 5: The method of any of aspects 1 through 4, wherein a duration for the first active duration is based at least in part on a latency value associated with the sidelink signal, the sidelink response, or both.

Aspect 6: The method of any of aspects 1 through 5, wherein the first active duration is based at least in part on a reliability target associated with the sidelink signal or the sidelink response, a priority associated with the sidelink signal, the sidelink response, or both.

Aspect 7: The method of any of aspects 1 through 6, wherein activating the first active duration comprises: activating a first portion of the first active duration, the first portion comprising a duration for switching from the transmission mode to the reception mode; and activating a second portion of the first active duration, the second portion comprising a duration for receiving the sidelink response to the sidelink signal during the first active duration.

Aspect 8: The method of aspect 7, wherein the second portion of the first active duration is activated upon expiration of the first portion of the first active duration.

Aspect 9: The method of any of aspects 1 through 8, wherein the sidelink signal comprises sidelink control information or a medium access control (MAC) control element (MAC-CE) and the sidelink response comprises one or more MAC-CEs.

Aspect 10: The method of any of aspects 1 through 9, wherein activating the first active duration comprises activating a medium access control (MAC) control element (CE) timer.

Aspect 11: The method of any of aspects 1 through 10, wherein the sidelink signal and the sidelink response comprise one or more PC5 control messages and activating the first active duration comprises activating a PC5 radio resource control (PC5RRC) timer or a sidelink timer.

Aspect 12: The method of any of aspects 1 through 11, wherein terminating the first active duration comprises terminating a medium access control (MAC) control element (CE) timer, a PC5 radio resource control (PC5RRC) timer, or a sidelink timer.

Aspect 13: The method of any of aspects 1 through 12, further comprising: determining that the first active duration overlaps with a second active duration within an active duration of a second discontinuous cycle associated with the second UE; and modifying the first active duration based at least in part on the determining.

Aspect 14: The method of aspect 13, wherein the active duration of the second discontinuous cycle occurs prior to the active duration of the first discontinuous cycle, the modifying the first active duration further comprising: delaying activation of the first active duration within the active duration of the first discontinuous cycle based at least in part on the determining.

Aspect 15: The method of any of aspects 13 through 14, wherein the active duration of the second discontinuous cycle occurs after the active duration of the first discontinuous cycle, the modifying the duration of the first active duration further comprising: terminating the first active duration at a beginning of the second active duration based at least in part on the determining.

Aspect 16: The method of any of aspects 13 through 15, further comprising: modifying the duration of the first active duration based at least in part on respective communication priorities associated with the first active duration and the second active duration.

Aspect 17: A method for wireless communications at a first UE, comprising: receiving a message indicating a configuration for a first active duration for the first UE, the first active duration being for a reversed communication direction during an active duration of a first discontinuous cycle for sidelink communications for the first UE; receiving, within the active duration of the first discontinuous cycle, a sidelink signal from a second UE; activating the first active duration based at least in part on receiving the sidelink signal based at least in part on the configuration; switching from a reception mode to a transmission mode during the first active duration based at least in part on activating the first active duration; transmitting, based at least in part on switching from the reception mode to the transmission mode, a sidelink response to the sidelink signal from the second UE during the first active duration based at least in part on activating the first active duration and in accordance with the configuration; and terminating the first active duration based at least in part on transmitting the sidelink response.

Aspect 18: The method of aspect 17, wherein the sidelink signal comprises a triggering indication or a sidelink measurement reference signal, the method further comprising: receiving the sidelink signal during a first symbol or a first slot within the active duration of the first discontinuous cycle; and activating the first active duration at a second symbol following the first symbol or slot or at a second slot following the first slot based at least in part on the receiving.

Aspect 19: The method of aspect 18, wherein the triggering indication comprises a channel state information request, a reference signal received power request, a channel busy ratio request, a beam request, or any combination thereof.

Aspect 20: The method of any of aspects 17 through 19, further comprising: processing the sidelink signal within the first active duration; and switching from the reception mode to the transmission mode during the first active duration, wherein the transmission mode comprises sensing and resource selection for the sidelink signal.

Aspect 21: The method of any of aspects 17 through 20, wherein a duration for the first active duration is based at least in part on a latency value associated with the sidelink signal, the sidelink response, or both.

Aspect 22: The method of any of aspects 17 through 21, wherein the first active duration is based at least in part on a reliability target associated with the sidelink signal or the sidelink response, a priority associated with the sidelink signal or the sidelink response, or both.

Aspect 23: The method of any of aspects 17 through 22, wherein activating the first active duration comprises: activating a first portion of the first active duration, the first portion comprising a duration for switching from the reception mode to the transmission mode; and activating a second portion of the first active duration, the second portion comprising a duration for transmitting the sidelink response to the sidelink signal during the first active duration.

Aspect 24: The method of aspect 23, wherein the second portion of the first active duration is activated upon expiration of the first portion of the first active duration.

Aspect 25: The method of any of aspects 17 through 24, further comprising: switching from the transmission mode to the reception mode after the first active duration.

Aspect 26: The method of any of aspects 17 through 25, wherein the sidelink signal comprises sidelink control information or a medium access control (MAC) control element (MAC-CE) and the sidelink response comprises one or more MAC-CEs.

Aspect 27: The method of any of aspects 17 through 26, wherein activating the first active duration comprises activating a medium access control (MAC) control element (CE) timer, a PC5 radio resource control (PCSRRC) timer, or a sidelink timer.

Aspect 28: The method of any of aspects 17 through 27, wherein terminating the first active duration comprises terminating a medium access control (MAC) control element (CE) timer, a PC5 radio resource control (PCSRRC) timer, or a sidelink timer.

Aspect 29: The method of any of aspects 17 through 28, further comprising: determining that the first active duration overlaps with a second active duration within an active duration of a second discontinuous cycle associated with the second UE; and modifying the first active duration based at least in part on the determining.

Aspect 30: The method of aspect 29, wherein the active duration of the second discontinuous cycle occurs prior to the active duration of the first discontinuous cycle, the modifying the first active duration further comprising: delaying activation of the first active duration within the active duration of the first discontinuous cycle based at least in part on the determining.

Aspect 31: The method of any of aspects 29 through 30, wherein the active duration of the second discontinuous cycle occurs after the active duration of the first discontinuous cycle, the modifying the first active duration further comprising: terminating the first active duration at the beginning of the second active duration based at least in part on the determining.

Aspect 32: The method of any of aspects 29 through 31, further comprising: modifying the duration of the first active duration based at least in part on respective communication priorities associated with the first active duration and the second active duration.

Aspect 33: A method for wireless communications at a first UE, comprising: receiving a message indicating a configuration for a first timer for the first UE, the first timer for switching a communication direction during a first active duration of a discontinuous cycle for sidelink communications for the first UE; transmitting, within the first active duration of the discontinuous cycle, a sidelink signal to a second UE; activating the first timer based at least in part on transmitting the sidelink signal based at least in part on the configuration; switching from a transmission mode to a reception mode during the first active duration based at least in part on activating the first timer; receiving, based at least in part on switching from the transmission mode to the reception mode, a sidelink response to the sidelink signal from the second UE during the first active duration based at least in part on activating the first timer and in accordance with the configuration; and switching from the reception mode to the transmission mode during the first active duration based at least in part on receiving the sidelink response.

Aspect 34: The method of aspect 33, wherein the sidelink signal comprises a triggering indication, a sidelink measurement reference signal, or a sidelink message, the method further comprising: transmitting the sidelink signal during a first symbol or a first slot within the first active duration; and activating the first timer at a second symbol following the first slot or a second slot following the first slot based at least in part on the transmitting.

Aspect 35: The method of aspect 34, wherein the triggering indication comprises a channel state information request, a reference signal received power request, a channel busy ratio request, a beam request, or any combination thereof.

Aspect 36: The method of any of aspects 33 through 35, further comprising: switching from the reception mode to the transmission mode during the first active duration, wherein the transmission mode comprises sensing and resource selection for the sidelink signal.

Aspect 37: The method of any of aspects 33 through 36, wherein a duration for the first timer is based at least in part on a latency value associated with the sidelink signal, the sidelink response, or both.

Aspect 38: The method of any of aspects 33 through 37, wherein the first timer is based at least in part on a reliability target associated with the sidelink signal or the sidelink response, a priority associated with the sidelink signal, the sidelink response, or both.

Aspect 39: The method of any of aspects 33 through 38, wherein activating the first timer comprises: activating a first portion of the first timer, the first portion comprising a duration for switching from the transmission mode to the reception mode; and activating a second portion of the first timer, the second portion comprising a duration for receiving the sidelink response to the sidelink signal during the first active duration.

Aspect 40: The method of aspect 39, wherein the second portion of the first timer is activated upon expiration of the first portion of the first timer.

Aspect 41: The method of any of aspects 33 through 40, further comprising: deactivating the first timer and switching from the reception mode to the transmission mode during the first active duration and based at least in part on receiving the sidelink response.

Aspect 42: The method of any of aspects 33 through 41, wherein the sidelink signal comprises sidelink control information or a medium access control (MAC) control element (MAC-CE) and the sidelink response comprises one or more MAC-CEs.

Aspect 43: The method of any of aspects 33 through 42, wherein the first timer comprises a medium access control (MAC) control element (MAC-CE) timer.

Aspect 44: The method of any of aspects 33 through 43, wherein the sidelink signal and the sidelink response comprise one or more PC5 control messages and the first timer comprises an RRC timer or a PC5 sidelink timer.

Aspect 45: The method of any of aspects 33 through 44, further comprising: determining that a duration associated with the first timer overlaps a duration associated with a second timer within a second active duration of a second discontinuous cycle associated with the second UE; and modifying the duration of the first timer based at least in part on the determining.

Aspect 46: The method of aspect 45, wherein the second active duration of the second discontinuous cycle occurs prior to the first active duration, the modifying the duration of the first timer further comprising: delaying activation of the first timer within the first active duration of the first discontinuous cycle based at least in part on the determining.

Aspect 47: The method of any of aspects 45 through 46, wherein the second active duration of the second discontinuous cycle occurs after the first active duration, the modifying the duration of the first timer further comprising: terminating the first timer at the beginning of the second active duration based at least in part on the determining.

Aspect 48: The method of any of aspects 45 through 47, further comprising: modifying the duration of the first timer based at least in part on respective channel priorities associated with the first active duration and the second active duration.

Aspect 49: A method for wireless communications at a first UE, comprising: receiving a message indicating a configuration for a first timer for the first UE, the first timer for switching a communication direction during a first active duration of a discontinuous cycle for sidelink communications for the first UE; receiving, within the first active duration of the discontinuous cycle, a sidelink signal from a second UE; activating the first timer based at least in part on receiving the sidelink signal based at least in part on the configuration; switching from a reception mode to a transmission mode during the first active duration based at least in part on activating the first timer; transmitting, based at least in part on switching from the reception mode to the transmission mode, a sidelink response to the sidelink signal from the second UE during the first active duration based at least in part on activating the first timer and in accordance with the configuration; and switching from the transmission mode to the reception mode during the first active duration based at least in part on transmitting the sidelink response.

Aspect 50: The method of aspect 49, wherein the sidelink signal comprises a triggering indication or a sidelink measurement reference signal, the method further comprising: receiving the sidelink signal during a first symbol or a first slot within the first active duration; and activating the first timer at a second symbol following the first slot or a second slot following the first slot based at least in part on the receiving.

Aspect 51: The method of aspect 50, wherein the triggering indication comprises a channel state information request, a reference signal received power request, a channel busy ratio request, a beam request, or any combination thereof.

Aspect 52: The method of any of aspects 49 through 51, further comprising: processing the sidelink signal within the first active duration; and switching from the reception mode to the transmission mode during the first active duration, wherein the transmission mode comprises sensing and resource selection for the sidelink signal.

Aspect 53: The method of any of aspects 49 through 52, wherein a duration for the first timer is based at least in part on a latency value associated with the sidelink signal, the sidelink response, or both.

Aspect 54: The method of any of aspects 49 through 53, wherein the first timer is based at least in part on a reliability target associated with the sidelink signal or the sidelink response, a priority associated with the sidelink signal or the sidelink response, or both.

Aspect 55: The method of any of aspects 49 through 54, wherein activating the first timer comprises: activating a first portion of the first timer, the first portion comprising a duration for switching from the reception mode to the transmission mode; and activating a second portion of the first timer, the second portion comprising a duration for transmitting the sidelink response to the sidelink signal during the first active duration.

Aspect 56: The method of aspect 55, wherein the second portion of the first timer is activated upon expiration of the first portion of the first timer.

Aspect 57: The method of any of aspects 49 through 56, further comprising: deactivating the first timer and switching from the transmission mode to the reception mode during the first active duration and based at least in part on transmitting the sidelink response.

Aspect 58: The method of any of aspects 49 through 57, wherein the sidelink signal comprises sidelink control information or a medium access control (MAC) control element (MAC-CE) and the sidelink response comprises one or more MAC-CEs.

Aspect 59: The method of any of aspects 49 through 58, wherein the first timer comprises medium access control (MAC) control elements (MAC-CE) timer.

Aspect 60: The method of any of aspects 49 through 59, wherein the sidelink signal and the sidelink response comprise one or more PC5 control messages and the first timer comprises an RRC timer or a PC5 sidelink timer.

Aspect 61: The method of any of aspects 49 through 60, further comprising: determining that a duration associated with the first timer overlaps a duration associated with a second timer within a second active duration of a second discontinuous cycle associated with the second UE; and modifying the duration of the first timer based at least in part on the determining.

Aspect 62: The method of aspect 61, wherein the second active duration of the second discontinuous cycle occurs prior to the first active duration, the modifying the duration of the first timer further comprising: delaying activation of the first timer within the first active duration of the first discontinuous cycle based at least in part on the determining.

Aspect 63: The method of any of aspects 61 through 62, wherein the second active duration of the second discontinuous cycle occurs after the first active duration, the modifying the duration of the first timer further comprising: terminating the first timer at the beginning of the second active duration based at least in part on the determining.

Aspect 64: The method of any of aspects 61 through 63, further comprising: modifying the duration of the first timer based at least in part on respective channel priorities associated with the first active duration and the second active duration.

Aspect 65: An apparatus for wireless communications at a first UE, comprising a processor; memory coupled with the processor; and instructions stored in the memory and executable by the processor to cause the apparatus to perform a method of any of aspects 1 through 16.

Aspect 66: An apparatus for wireless communications at a first UE, comprising at least one means for performing a method of any of aspects 1 through 16.

Aspect 67: A non-transitory computer-readable medium storing code for wireless communications at a first UE, the code comprising instructions executable by a processor to perform a method of any of aspects 1 through 16.

Aspect 68: An apparatus for wireless communications at a first UE, comprising a processor; memory coupled with the processor; and instructions stored in the memory and executable by the processor to cause the apparatus to perform a method of any of aspects 17 through 32.

Aspect 69: An apparatus for wireless communications at a first UE, comprising at least one means for performing a method of any of aspects 17 through 32.

Aspect 70: A non-transitory computer-readable medium storing code for wireless communications at a first UE, the code comprising instructions executable by a processor to perform a method of any of aspects 17 through 32.

Aspect 71: An apparatus for wireless communications at a first UE, comprising a processor; memory coupled with the processor; and instructions stored in the memory and executable by the processor to cause the apparatus to perform a method of any of aspects 33 through 48.

Aspect 72: An apparatus for wireless communications at a first UE, comprising at least one means for performing a method of any of aspects 33 through 48.

Aspect 73: A non-transitory computer-readable medium storing code for wireless communications at a first UE, the code comprising instructions executable by a processor to perform a method of any of aspects 33 through 48.

Aspect 74: An apparatus for wireless communications at a first UE, comprising a processor; memory coupled with the processor; and instructions stored in the memory and executable by the processor to cause the apparatus to perform a method of any of aspects 49 through 64.

Aspect 75: An apparatus for wireless communications at a first UE, comprising at least one means for performing a method of any of aspects 49 through 64.

Aspect 76: A non-transitory computer-readable medium storing code for wireless communications at a first UE, the code comprising instructions executable by a processor to perform a method of any of aspects 49 through 64.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first user equipment (UE), comprising:
a processor;
memory coupled with the processor; and
instructions stored in the memory and executable by the processor to cause the apparatus to:
receive a message indicating a configuration for a first active duration for the first UE, the first active duration being for a reversed communication direction during an active duration of a first discontinuous cycle for sidelink communications for the first UE;
transmit, within the active duration of the first discontinuous cycle, a sidelink signal to a second UE;
activate the first active duration based at least in part on transmitting the sidelink signal based at least in part on the configuration;
switch from a transmission mode to a reception mode during the first active duration based at least in part on activating the first active duration;
receive, based at least in part on switching from the transmission mode to the reception mode, a sidelink response to the sidelink signal from the second UE during the first active duration based at least in part on activating the first active duration and in accordance with the configuration; and
terminate the first active duration based at least in part on receiving the sidelink response.

2. The apparatus of claim 1, wherein the sidelink signal comprises a triggering indication, and the instructions are further executable by the processor to cause the apparatus to:
transmit the sidelink signal during a first symbol or a first slot within the active duration of the first discontinuous cycle; and
activate the first active duration at a second symbol following the first symbol or slot or at a second slot following the first slot based at least in part on the transmitting.

3. The apparatus of claim 2, wherein the triggering indication comprises a channel state information request, a reference signal received power request, a channel busy ratio request, a beam request, or any combination thereof.

4. The apparatus of claim 1, wherein the instructions are further executable by the processor to cause the apparatus to:
switch from the reception mode to the transmission mode after the first active duration.

5. The apparatus of claim 1, wherein a duration for the first active duration is based at least in part on a latency value associated with the sidelink signal, the sidelink response, or both.

6. The apparatus of claim 1, wherein the first active duration is based at least in part on a reliability target associated with the sidelink signal or the sidelink response, a priority associated with the sidelink signal, the sidelink response, or both.

7. The apparatus of claim 1, wherein the instructions to activate the first active duration are executable by the processor to cause the apparatus to:
activate a first portion of the first active duration, the first portion comprising a duration for switching from the transmission mode to the reception mode; and
activate a second portion of the first active duration, the second portion comprising a duration for receiving the sidelink response to the sidelink signal during the first active duration.

8. The apparatus of claim 7, wherein the second portion of the first active duration is activated upon expiration of the first portion of the first active duration.

9. The apparatus of claim 1, wherein the sidelink signal comprises sidelink control information or a medium access control (MAC) control element (MAC-CE) and the sidelink response comprises one or more MAC-CEs.

10. The apparatus of claim 1, wherein activating the first active duration comprises activating a medium access control (MAC) control element (MAC-CE) timer.

11. The apparatus of claim 1, wherein the sidelink signal and the sidelink response comprise one or more PC5 control messages and activating the first active duration comprises activating a PC5 radio resource control (PC5RRC) timer or a sidelink timer.

12. The apparatus of claim 1, wherein terminating the first active duration comprises terminating a medium access control (MAC) control element (MAC-CE) timer, a PC5 radio resource control (PC5RRC) timer, or a sidelink timer.

13. The apparatus of claim 1, wherein the instructions are further executable by the processor to cause the apparatus to:
determine that the first active duration overlaps with a second active duration within an active duration of a second discontinuous cycle associated with the second UE; and
modify the first active duration based at least in part on the determining.

14. The apparatus of claim 13, wherein the active duration of the second discontinuous cycle occurs prior to the active duration of the first discontinuous cycle, the instructions to modify the first active duration are further executable by the processor to cause the apparatus to:
delay activation of the first active duration within the active duration of the first discontinuous cycle based at least in part on the determining.

15. The apparatus of claim 13, wherein the active duration of the second discontinuous cycle occurs after the active duration of the first discontinuous cycle, the instructions to modify the duration of the first active duration are further executable by the processor to cause the apparatus to:
terminate the first active duration at a beginning of the second active duration based at least in part on the determining.

16. An apparatus for wireless communications at a first user equipment (UE), comprising:
a processor;
memory coupled with the processor; and
instructions stored in the memory and executable by the processor to cause the apparatus to:
receive a message indicating a configuration for a first active duration for the first UE, the first active duration being for a reversed communication direction during an active duration of a first discontinuous cycle for sidelink communications for the first UE;
receive, within the active duration of the first discontinuous cycle, a sidelink signal from a second UE;
activate the first active duration based at least in part on receiving the sidelink signal based at least in part on the configuration;
switch from a reception mode to a transmission mode during the first active duration based at least in part on activating the first active duration;
transmit, based at least in part on switching from the reception mode to the transmission mode, a sidelink response to the sidelink signal from the second UE during the first active duration based at least in part on activating the first active duration and in accordance with the configuration; and
terminate the first active duration based at least in part on transmitting the sidelink response.

17. The apparatus of claim 16, wherein the sidelink signal comprises a triggering indication or a sidelink measurement reference signal, and the instructions are further executable by the processor to cause the apparatus to:
receive the sidelink signal during a first symbol or a first slot within the active duration of the first discontinuous cycle; and
activate the first active duration at a second symbol following the first symbol or slot or at a second slot following the first slot based at least in part on the receiving.

18. The apparatus of claim 17, wherein the triggering indication comprises a channel state information request, a reference signal received power request, a channel busy ratio request, a beam request, or any combination thereof.

19. The apparatus of claim 16, wherein the instructions are further executable by the processor to cause the apparatus to:
process the sidelink signal within the first active duration; and
switch from the reception mode to the transmission mode during the first active duration, wherein the transmission mode comprises sensing and resource selection for the sidelink signal.

20. The apparatus of claim 16, wherein a duration for the first active duration is based at least in part on a latency value associated with the sidelink signal, the sidelink response, or both.

21. The apparatus of claim 16, wherein the first active duration is based at least in part on a reliability target associated with the sidelink signal or the sidelink response, a priority associated with the sidelink signal or the sidelink response, or both.

22. The apparatus of claim 16, wherein the instructions to activate the first active duration are executable by the processor to cause the apparatus to:
activate a first portion of the first active duration, the first portion comprising a duration for switching from the reception mode to the transmission mode; and
activate a second portion of the first active duration, the second portion comprising a duration for transmitting the sidelink response to the sidelink signal during the first active duration.

23. The apparatus of claim 22, wherein the second portion of the first active duration is activated upon expiration of the first portion of the first active duration.

24. The apparatus of claim 16, wherein the instructions are further executable by the processor to cause the apparatus to:
switch from the transmission mode to the reception mode after the first active duration.

25. The apparatus of claim 16, wherein the sidelink signal comprises sidelink control information or a medium access control (MAC) control element (MAC-CE) and the sidelink response comprises one or more MAC-CEs.

26. The apparatus of claim 16, wherein activating the first active duration comprises activating a medium access control (MAC) control element (MAC-CE) timer, a PC5 radio resource control (PC5RRC) timer, or a sidelink timer.

27. The apparatus of claim 16, wherein terminating the first active duration comprises terminating a medium access control (MAC) control element (MAC-CE) timer, a PC5 radio resource control (PC5RRC) timer, or a sidelink timer.

28. The apparatus of claim 16, wherein the instructions are further executable by the processor to cause the apparatus to:
determine that the first active duration overlaps with a second active duration within an active duration of a second discontinuous cycle associated with the second UE; and
modify the first active duration based at least in part on the determining.

29. A method for wireless communications at a first user equipment (UE), comprising:
receiving a message indicating a configuration for a first active duration for the first UE, the first active duration being for a reversed communication direction during an active duration of a first discontinuous cycle for sidelink communications for the first UE;
transmitting, within the active duration of the first discontinuous cycle, a sidelink signal to a second UE;
activating the first active duration based at least in part on transmitting the sidelink signal based at least in part on the configuration;
switching from a transmission mode to a reception mode during the first active duration based at least in part on activating the first active duration;
receiving, based at least in part on switching from the transmission mode to the reception mode, a sidelink response to the sidelink signal from the second UE during the first active duration based at least in part on activating the first active duration and in accordance with the configuration; and
terminating the first active duration based at least in part on receiving the sidelink response.

30. A method for wireless communications at a first user equipment (UE), comprising:
receiving a message indicating a configuration for a first active duration for the first UE, the first active duration being for a reversed communication direction during an active duration of a first discontinuous cycle for sidelink communications for the first UE;
receiving, within the active duration of the first discontinuous cycle, a sidelink signal from a second UE;
activating the first active duration based at least in part on receiving the sidelink signal based at least in part on the configuration;
switching from a reception mode to a transmission mode during the first active duration based at least in part on activating the first active duration;
transmitting, based at least in part on switching from the reception mode to the transmission mode, a sidelink response to the sidelink signal from the second UE during the first active duration based at least in part on activating the first active duration and in accordance with the configuration; and
terminating the first active duration based at least in part on transmitting the sidelink response.
